(19) United States
(12) Patent Application Publication
(10) Pub. No.: US 2024/0030402 A1
(43) Pub. Date: Jan. 25, 2024

(54) ANODE FOR LITHIUM METAL BATTERY, LITHIUM METAL BATTERY COMPRISING ANODE AND MANUFACTURING METHOD FOR ANODE FOR LITHIUM METAL BATTERY

(71) Applicant: Samsung SDI Co., Ltd., Yongin-si (KR)

(72) Inventors: Kanghee Lee, Yongin-si (KR); Woojin Bae, Yongin-si (KR); Shinya Wakita, Yongin-si (KR); Junyong Lee, Yongin-si (KR); Jongseok Moon, Yongin-si (KR); Jongseok Park, Yongin-si (KR); Jinhwan Park, Yongin-si (KR); Hyunsik Woo, Yongin-si (KR); Heemin Kim, Yongin-si (KR)

(21) Appl. No.: 18/357,033

(22) Filed: Jul. 21, 2023

(30) Foreign Application Priority Data
Jul. 22, 2022 (KR) 10-2022-0091152

(51) Int. Cl. H01M 4/136; H01M 10/0525; H01M 4/40; H01M 4/62; H01M 4/1397; H01M 4/131

(52) U.S. Cl. CPC H01M 4/136; H01M 10/0525; H01M 4/405; H01M 4/625; H01M 4/1397; H01M 4/131; H01M 2004/027

(57) ABSTRACT

An anode for lithium metal batteries, a lithium metal battery including the anode, and a method of manufacturing the anode for lithium metal batteries are provided. The anode for lithium metal batteries includes: an anode current collector; and a protective layer on the anode current collector, where an anode active material layer is disposed or absent between the anode current collector and the protective layer, the protective layer may include sulfurized polyacrylonitrile, and the anode active material layer may include a lithium metal and/or a lithium alloy.

### CROSS-REFERENCE TO RELATED APPLICATION

This application claims priority to and the benefit of Korean Patent Application No. 10-2022-0091152, filed on Jul. 22, 2022, in the Korean Intellectual Property Office, the content of which is incorporated by reference herein in its entirety.

### BACKGROUND

### 1. Field

One or more embodiments of the present disclosure relate to an anode for lithium metal batteries, a lithium metal battery including the anode, and a method of manufacturing an anode for lithium metal batteries.

### 2. Description of the Related Art

Carbonaceous anode active materials such as graphite are widely utilized in lithium batteries in the related art at the present. Because there is no volume change in carbonaceous anode active materials during a charge/discharge process, lithium batteries have high stability. However, graphite has a low theoretical electric capacity of 372 mAh/g.

Lithium metal may be utilized as an anode active material. Lithium metal has a very high theoretical electric capacity of 3860 mAh/g. Lithium metal may cause short circuits between a cathode and an anode because dendrites (e.g., lithium dendrites) are formed and grow on the surface of the lithium metal by side reactions with an electrolyte during a charge/discharge process. As a result, lifespan characteristics of a lithium metal battery that include the lithium metal may deteriorate.

As such, there is a need and/or desire to develop methods for improving lifespan characteristics of a lithium metal battery including lithium metal.

### SUMMARY

One or more aspects of embodiments of the present disclosure are directed toward an anode for lithium metal batteries having a disclosed structure.

One or more aspects of embodiments of the present disclosure are directed toward a lithium metal battery including the anode having a disclosed structure.

One or more aspects of embodiments of the present disclosure are directed toward a method of manufacturing an anode for lithium metal batteries having a disclosed structure.

Additional aspects will be set forth in part in the description which follows and, in part, will be apparent from the description, or may be learned by practice of the presented embodiments of the disclosure.

According to one or more embodiments of the present disclosure, an anode for lithium metal batteries includes:
an anode current collector; and
a protective layer on the anode current collector,
wherein an anode active material layer is disposed or absent between the anode current collector and the protective layer,
the protective layer includes sulfurized polyacrylonitrile (SPAN), and
the anode active material layer includes a lithium metal and/or a lithium alloy.

According to one or more embodiments of the present disclosure, a lithium metal battery includes:
a cathode; the anode; and
an electrolyte between the cathode and the anode.

According to one or more embodiments of the present disclosure, a method of manufacturing an anode for lithium metal batteries includes:
providing an anode current collector or providing a stack structure in which an anode active material layer is on an anode current collector; and
providing a protective layer on the anode current collector or on the anode active material layer,
wherein the protective layer includes sulfurized polyacrylonitrile (SPAN), and
the anode active material layer includes a lithium metal and/or a lithium alloy.

### BRIEF DESCRIPTION OF THE DRAWINGS

The accompanying drawings are included to provide a further understanding of the present disclosure and are incorporated in and constitute a part of the present disclosure. The drawings illustrate embodiments of the present disclosure and, together with the description, serve to explain principles of the present disclosure. The above and other aspects, features, and advantages of certain embodiments of the disclosure will be more apparent from the following description taken in conjunction with the accompanying drawings, in which:

FIG. 1 is a cross-sectional view of an anode according to one or more embodiments of the present disclosure.

FIG. 2 is a cross-sectional view of an anode according to one or more embodiments of the present disclosure.

FIG. 3 is a cross-sectional view of an anode according to one or more embodiments of the present disclosure.

FIG. 4 is a cross-sectional view of an anode according to one or more embodiments of the present disclosure.

FIG. 5 is a schematic diagram of a lithium metal battery according to one or more embodiments of the present disclosure.

FIG. 6 is a schematic diagram of a lithium metal battery according to one or more embodiments of the present disclosure.

FIG. 7 is a schematic diagram of a lithium metal battery according to one or more embodiments of the present disclosure.

FIG. 8 is a cross-sectional view of a lithium metal battery including a solid electrolyte layer, according to one or more embodiments of the present disclosure.

FIG. 9 is a cross-sectional view of a lithium metal battery including a solid electrolyte layer, according to one or more embodiments of the present disclosure.

### DETAILED DESCRIPTION

Reference will now be made in more detail to embodiments, examples of which are illustrated in the accompanying drawings, wherein like reference numerals refer to like elements throughout the present disclosure, and duplicative descriptions thereof may not be provided for conciseness. In this regard, the embodiments of the present disclosure may have different forms and should not be construed as being limited to the descriptions set forth herein. Accordingly, the embodiments of the present disclosure are merely described, by referring to the drawings, to explain aspects of the present disclosure. As utilized herein, the terms “and/or” and “or” may include any and all combinations of one or more of the associated listed items. Expressions such as “at least one of,” “one of,” and “at least one selected from,” if preceding a list of elements, modify the entire list of elements and do not modify the individual elements of the list. For example, “at least one of a, b, or c”, “at least one selected from a, b, and c”, “at least one selected from among a to c”, etc., may indicate only a, only b, only c, both (e.g., simultaneously) a and b, both (e.g., simultaneously) a and c, both (e.g., simultaneously) b and c, all of a, b, and c, or variations thereof.

During charge/discharge processes of lithium metal batteries including lithium metal as an anode active material, a lithium-containing metal layer is plated and dissolved between an anode current collector and an electrolyte layer. As the charge/discharge process of a lithium metal battery is repeated, the lithium-containing metal layer may include or retain impurities remaining in electrodes, decomposition products of an electrolyte, and/or the like. Therefore, the lithium-containing metal layer may have a rough and hard surface by including these impurities. As a result, lithium dendrites may be formed on a lithium-containing metal layer having such a rough surface. These lithium dendrites may continuously grow during charge/discharge processes, thereby causing short circuits between a cathode and an anode.

Because an anode according to one or more embodiments of the present disclosure has a structure disclosed herein, formation of lithium dendrites is inhibited on an anode active material layer, and short circuits are inhibited in a lithium metal battery including the anode, resulting in improvement of cycle characteristics of the lithium metal battery.

Embodiments of the present disclosure may have one or more suitable changes and numerous embodiments, particular embodiments will be illustrated in the drawings and described in more detail in the written description. However, this is not intended to limit the disclosure to particular modes of practice, and it is to be appreciated that all modifications, equivalents, and substitutes that do not depart from the spirit and technical scope of the disclosure are encompassed in the present disclosure.

The terms utilized herein are merely utilized to describe particular embodiments and are not intended to limit the present disclosure. An expression utilized in the singular encompasses the expression of the plural, unless it has a clearly different meaning in the context. In the present specification, it is to be understood that the terms such as “comprising,” “including,” “having,” etc., are intended to indicate the existence of the features, numbers, operations, elements, parts, components, materials, or combinations thereof disclosed in the specification, and are not intended to preclude the possibility that one or more other features, numbers, operations, elements, parts, components, materials, or combinations thereof may exist or may be added. As utilized herein, the “/” may be interpreted as either “and” or “or” depending on situations.

In the drawings, thicknesses of one or more suitable layers and regions may be enlarged or reduced for clarity. Throughout the present disclosure, like reference numerals denote like elements. Throughout the present disclosure, it will be understood that if one element such as layer, film, region, or plate, is referred to as being “on” another element, it may be directly on the other element, or intervening elements may also be present therebetween. Although the terms “first,” “second,” etc. may be utilized herein to describe one or more suitable components, these components should not be limited by these terms. These terms are only utilized to distinguish one component from another. In the disclosure and drawings, components having substantially the same functional configuration are referred to by the same reference numerals, and redundant descriptions are omitted for conciseness.

In the present disclosure, a “particle diameter” of particles indicates an average diameter of spherical (e.g., substantially spherical) particles or an average length of major axes of non-spherical particles. Particle diameters of particles may be measured utilizing a particle size analyzer (PSA). The “particle diameter” of particles may be, for example, an average particle diameter. The average particle diameter may refer to, for example, a median particle diameter (D50). The median particle diameter D50 may refer to a particle diameter corresponding to a 50% cumulative volume calculated from the smallest particle to the largest particle in a particle size distribution measured, for example, by laser diffraction method.

In the present disclosure, the term “metal” may include metals and metalloids such as silicon and germanium in an elemental or ionic state.

In the present disclosure, the term “alloy” may refer to a mixture of two or more metals.

In the present disclosure, the term “cathode active material” may refer to a material for cathodes allowing lithiation and delithiation.

In the present disclosure, the term “anode active material” may refer to a material for anodes allowing lithiation and delithiation.

In the present disclosure, the terms “lithiation” and “lithiating” may refer to a process of adding lithium to a cathode active material or an anode active material.

In the present disclosure, the terms “delithiation” and “delithiating” may refer to a process of removing lithium from a cathode active material or an anode active material.

In the present disclosure, the terms “charging” and “charge” may refer to a process of supplying electrochemical energy to a battery.

In the present disclosure, the terms “discharging” and “discharge” may refer to a process of removing electrochemical energy from a battery.

In the present disclosure, the terms “cathode” and “positive electrode” may refer to an electrode in which electrochemical reduction and lithiation occur during discharging.

In the present disclosure, the terms “anode” and “negative electrode” may refer to an electrode in which electrochemical oxidation and delithiation occur during discharging.

Hereinafter, an anode for lithium metal batteries, a lithium metal battery including the anode, and a method of manufacturing the anode for lithium metal batteries will be described in more detail.

Anode

An anode for lithium metal batteries according to one or more embodiments may include: an anode current collector; and a protective layer disposed on the anode current collector, wherein an anode active material layer is disposed or absent between the anode current collector and the protective layer, the protective layer may include sulfurized polyacrylonitrile SPAN, and the anode active material layer may include a lithium metal and/or a lithium alloy. The protective layer including sulfurized polyacrylonitrile may have reduced reactivity toward an electrolyte. By inclusion of the protective layer including sulfurized polyacrylonitrile, deterioration caused, for example, by the electrolyte may be inhibited. For example, side reactions between the protective layer including sulfurized polyacrylonitrile and the electrolyte, such as, electrolytic solution, may be inhibited. By disposing the protective layer including sulfurized polyacrylonitrile on the anode active material layer, side reactions between the anode active material layer and the electrolyte may be effectively prevented, reduced and/or inhibited. The protective layer including sulfurized polyacrylonitrile may effectively prevent or reduce formation and/or growth of lithium dendrites on the surface of an anode active material layer including a lithium metal. As a result, stability is improved in an anode including the protective layer including sulfurized polyacrylonitrile and a lithium battery including the same, and cycle characteristics of the lithium battery are improved.

In contrast, if a protective layer including polyacrylonitrile PAN is on the anode active material layer, the protective layer including polyacrylonitrile PAN may have an increased reactivity toward an electrolyte. Side reactions between the protective layer including polyacrylonitrile PAN and an electrolyte, such as an electrolytic solution, may significantly increase. Therefore, although the protective layer including polyacrylonitrile PAN is disposed on the anode active material layer, it may be difficult to effectively prevent or reduce or inhibit side reactions between the anode active material layer and the electrolyte. The protective layer including polyacrylonitrile PAN may not effectively inhibit formation and/or growth of lithium dendrites on the surface of the anode active material layer including a lithium metal. Stability of an anode and a lithium battery including the protective layer including polyacrylonitrile PAN may be reduced, thereby deteriorating cycle characteristics of the lithium battery.

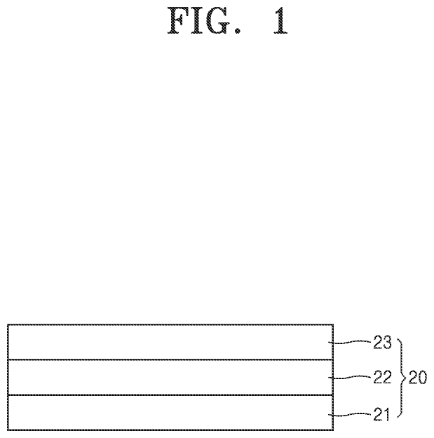

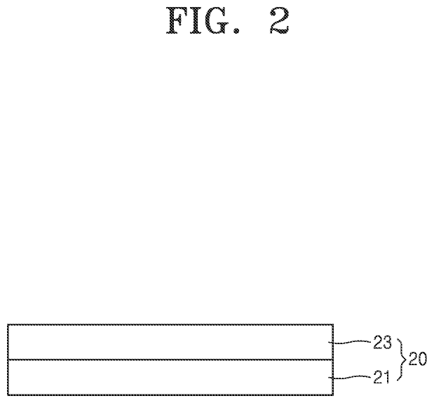

Referring to FIG. 1, in one or more embodiments, an anode 20 may include: an anode current collector 21; a protective layer 23 on the anode current collector 21; and an anode active material layer 22 between the anode current collector 21 and the protective layer 23, wherein the protective layer 23 may include sulfurized polyacrylonitrile SPAN and the anode active material layer 22 may include a lithium metal and/or a lithium alloy. Referring to FIG. 2, in some embodiments, an anode 20 may include: an anode current collector 21; and a protective layer 23 on the anode current collector 21, wherein an anode active material layer is absent between the anode current collector 21 and the protective layer 23, the protective layer 23 may include sulfurized polyacrylonitrile SPAN. Further, after charging, an anode active material layer may be disposed between the anode current collector 21 and the protective layer 23, and the anode active material layer may include a lithium metal or a lithium alloy.

### Anode: Protective Layer

Referring to FIGS. 1 to 4, in one or more embodiments, the anode 20 may include: the anode current collector 21; and the protective layer 23 on the anode current collector 21. The protective layer 23 may include sulfurized polyacrylonitrile SPAN. Because the protective layer 23 includes sulfurized polyacrylonitrile SPAN with low reactivity toward the electrolyte, deterioration of the anode active material layer including the lithium metal may be prevented or reduced. Because sulfurized polyacrylonitrile has a three-dimensionally crosslinked fused ring, structural stability of the protective layer may be improved. Because sulfurized polyacrylonitrile includes a number of nitrogen (N) atoms derived from a nitrile group, stability of the protective layer may be improved. For example, nitrogen atoms contained in sulfurized polyacrylonitrile react with lithium ions to form a lithium nitride such as Li₃N during a charge/discharge process, and the lithium nitride may provide additional ionic conductivity to the protective layer.

In one or more embodiments, sulfurized polyacrylonitrile may be produced, for example, by heating a raw material powder mixture including sulfur powder and polyacrylonitrile powder in a sealed non-oxidizing atmosphere. While sulfur powder and polyacrylonitrile powder are heated, ring closure reaction in which polyacrylonitrile is three-dimensionally crosslinked to form a fused ring, e.g., a 6-membered ring, proceeds concurrently (e.g., simultaneously) with reaction between sulfur and polyacrylonitrile, thereby obtaining sulfurized polyacrylonitrile in which sulfur binds to the fused ring. For example, in some embodiments, a plurality of sulfur atoms may be consecutively linked to constitute a part of the fused ring. For example, in some embodiments, three or more sulfur atoms may be consecutively linked to constitute a part of the fused ring. The fused ring may include nitrogen.

For example, in one or more embodiments, in an X-ray diffraction (XRD) spectrum of sulfurized polyacrylonitrile utilizing CuKα radiation, a peak of sulfur may disappear and only a peak with a broad portion at about 25° may be obtained in a diffraction angle (28) range of 20° to 30°.

For example, in one or more embodiments, in a Raman spectrum of sulfurized polyacrylonitrile, a main peak may be observed at a Raman shift of about 1330 cm⁻¹, and minor peaks may be observed in a range of 200 cm⁻¹ to 2000 cm⁻¹ at around 1561 cm⁻¹, 1512 cm⁻¹, 1447 cm⁻¹, 1150 cm⁻¹, 996 cm⁻¹, 942 cm⁻¹, 802 cm⁻¹, 474 cm⁻¹, 391 cm⁻¹, 365 cm⁻¹, and 305 cm⁻¹. The peaks may exist within a range of ±8 cm⁻¹ from a position of the peak. The main peak refers to a peak having a maximum peak height.

For example, in one or more embodiments, sulfurized polyacrylonitrile may be in the form of particles. An average particle diameter of sulfurized polyacrylonitrile (SPAN) may be, for example, from 100 nm to 10 μm or from 500 nm to 10 μm. In the embodiments in which sulfurized polyacrylonitrile has an average particle diameter within the range described above, reactivity toward the electrolytic solution may be more effectively inhibited.

In one or more embodiments, an amount of sulfurized polyacrylonitrile may be, for example, from 1 to 99 wt %, from 10 wt % to 90 wt %, from 20 wt % to 80 wt %, from 20 wt % to 50 wt %, or from 30 wt % to 50 wt % based on a total weight of the protective layer. In the embodiments in which the protective layer includes sulfurized polyacrylonitrile in an amount within the ranges described above, cycle characteristics of a lithium battery including the protective layer may further be improved.

In one or more embodiments, the protective layer 23 may further include Li₂S. Li₂S, for example, having an ionic conductivity of 1×10⁻⁵ S/cm or more, may provide additional ionic conductivity to the protective layer. Li₂S may be derived from sulfurized polyacrylonitrile. Li₂S may be produced, for example, by reaction between sulfurized polyacrylonitrile and lithium ions during a charge process of the lithium battery. By further including Li₂S, the protective layer may have an increased ionic conductivity.

In one or more embodiments, the protective layer 23 may further include, for example, a binder. Because the protective layer includes sulfurized polyacrylonitrile and a binder, binding strength between sulfurized polyacrylonitrile molecules and/or between sulfurized polyacrylonitrile particles may further be increased. Because the protective layer includes a binder, the protective layer may constantly maintain a shape, mechanical strength of the protective layer may be improved, and the protective layer may prevent or reduce direct contact between the electrode and the anode active material layer more effectively.

The binder may be, for example, a non-conductive binder or a conductive binder. The conductive binder may be, for example, an ion conductive binder, an electron conductive binder, or a combination thereof.

In one or more embodiments, the binder may be, for example, polystyrene sulfonate (PSS), polyvinylidene fluoride-hexafluoropropylene copolymer (PVDF-HFP), polyvinyl fluoride (PVF), poly vinylidene fluoride (PVDF), poly(methyl methacrylate) (PMMA), polyethylene oxide (PEO), polyethylene glycol (PEG), polyacrylonitrile (PAN), polytetrafluoroethylene (PTFE), poly(3,4-ethylenedioxythiophene) (PEDOT), polypyrrole (PPY), polyaniline, polyacetylene, polytetrafluoroethylene (PTFE), styrene-butadiene rubber (SBR), polyimide (PI), polyamideimide (PAI), carboxymethylcellulose (CMC), polyvinyl chloride (PVC), modified polyphenylene oxide (PPO), polyethylene (PE), and/or polypropylene (PP), but embodiments of the present disclosure are not limited thereto. The ion conductive binder may include a polar functional group. An ion conductive binder including a polar functional group may be, for example, Nafion, Aquivion, Flemion, Gore, Aciplex, Morgane ADP, sulfonated poly(ether ether ketone) (SPEEK), sulfonated poly(arylene ether ketone ketone sulfone) (SPAEKKS), sulfonated poly(aryl ether ketone), (SPAEK), poly[bis(benzimidazobenzisoquinolinones)] (SPBIBI), poly(styrene sulfonate) (PSS), and/or lithium 9,10-diphenylanthracene-2-sulfonate (DPASLi+). The electron conductive binder may be, for example, polyacetylene, polythiophene, polypyrrole, poly(p-phenylene), poly(phenylenevinylene), poly(phenylenesulfide), and/or polyaniline.

In some embodiments, the binder may be, for example, a fluorine-based binder. The fluorine-based binder included in the protective layer may be, for example, polyvinylidene fluoride (PVDF), polytetrafluoroethylene (PTFE), and/or polyvinylidene fluoride-hexafluoropropylene copolymer (PVDF-HFP).

In one or more embodiments, an amount of the binder may be, for example, from 1 part by weight to 30 parts by weight, from 5 parts by weight to 30 parts by weight, or from 10 parts by weight to 30 parts by weight based on 100 parts by weight of the sulfurized polyacrylonitrile. In some embodiments, the amount of the binder contained in the protective layer may be, for example, from 1 wt % to 25 wt % or 5 wt % to 20 wt % based on the total weight of the protective layer. In the embodiments in which the amount of the binder contained in the protective layer is within the ranges described above, cycle characteristics of a lithium battery including the protective layer may further be improved.

In one or more embodiments, the protective layer 23 may further include a metal oxide. For example, the protective layer may include both (e.g., simultaneously) the sulfurized polyacrylonitrile SPAN (e.g., in the form of SPAN particles) and a metal oxide (e.g., in the form of metal oxide particles). The protective layer including both (e.g., simultaneously) the sulfurized polyacrylonitrile SPAN and the metal oxide is, for example, an organic/inorganic composite protective layer. In the embodiments in which the protective layer further includes a metal oxide, strength and/or elasticity of the protective layer may be improved. Because durability of the protective layer is improved, precipitation and/or growth of lithium dendrites may be more effectively prevented or reduced in (e.g., at) an interface between the protective layer and the anode active material layer. Cycle characteristics of a lithium battery including the protective layer may further be improved.

For example, in some embodiments, the metal oxide may be in the form of particles. A shape of the metal oxide is not particularly limited. Metal oxide particles may include, for example, spherical particles (e.g., substantially spherical particles), plate-like particles, acicular particles, or any combination thereof. The metal oxide particles may have, for example, a non-substantially uniform shape. An average particle diameter of the metal oxide may be, for example, from 100 nm to 2 μm, from 200 nm to 1 μm, or from 400 nm to 1 μm. If the particle diameter of the metal oxide is within the ranges described above, cycle characteristics of a lithium battery including the protective layer may further be improved. The metal oxide may be, for example, porous or non-porous. The metal oxide may be, for example, crystalline or amorphous.

For example, in one or more embodiments, the metal oxide may include Nb₂O₅, TiO₂, Al₂O₃, SiO₂, BaTiO₃, metal organic framework (MOF), polyhedral oligomeric silsesquioxanes (POSS), Li₂CO₃, Li₃PO₄, Li₂O, montmorillonite, ZrO₂, CeO₂, Mn₃O₄, or any combination thereof, but embodiments of the present disclosure are not limited thereto, and any metal oxides commonly available in the art may also be utilized.

In one or more embodiments, the metal oxide may have, for example, lithiophilicity. The metal oxide having lithiophilicity may react with lithium ions during a charge/discharge process of a lithium battery. The metal oxide may include, for example, a pseudo-capacitive oxide reacting with lithium to form a lithium metal oxide. The pseudo-capacitive oxide may be, for example, Nb₂O₅ and TiO₂. The Nb₂O₅ may have, for example, an orthorhombic crystal structure. For example, the Nb₂O₅ may react with lithium ions during a charge/discharge process of a lithium battery to form LiₓNb₂O₅ (where 0<x<1). The pseudo-capacitive oxide serving as a pseudo capacitor may play a role in storing and/or dispersing lithium in the protective layer. By including the pseudo-capacitive oxide, the protective layer may have improved lithium ion conductivity and prevent or reduce localization of lithium.

In one or more embodiments, an amount of the metal oxide may be, for example, from 5 parts by weight to 60 parts by weight, from 10 parts by weight to 50 parts by weight, from 10 parts by weight to 40 parts by weight, or from 10 parts by weight to 30 parts by weight based on 100 parts by weight of the sulfurized polyacrylonitrile. In some embodiments, The amount of the metal oxide contained in the protective layer may be, for example, from 1 wt % to 40 wt %, from 5 wt % to 30 wt %, or from 5 wt % to 20 wt % based on the total weight of the protective layer. In the embodiments in which the amount of the metal oxide contained in the protective layer is within the ranges described above, cycle characteristics of a lithium battery including the protective layer may further be improved.

In one or more embodiments, the protective layer 23 may further include a carbonaceous material. In some embodiments, the protective layer 23 may include, for example, sulfurized polyacrylonitrile SPAN (e.g., in the form of SPAN particles) and a carbonaceous material (in the form of carbonaceous particles, e.g., carbon particles, e.g., amorphous carbon particles). In some embodiments, the protective layer 23 may include, for example, sulfurized polyacrylonitrile SPAN, a metal oxide, and a carbonaceous material. Because the protective layer further includes the carbonaceous material, dispersion of the sulfurized polyacrylonitrile and/or the metal oxide may further be improved. Therefore, local precipitation and/or growth of lithium dendrites may be more effectively prevented or reduced in (e.g., at) an interface between the protective layer and the anode active material layer. The carbonaceous material may act as a carbonaceous dispersant. The carbonaceous material may be, for example, a carbonaceous conductive material. Because the protective layer includes the carbonaceous material, internal resistance of the protective layer may decrease and the protective layer may have conductivity. The carbonaceous material may be, for example, amorphous carbon. Because the protective layer includes amorphous carbon, lithium ions may move more quickly through the surface of amorphous carbon than through the inside of other part(s) or reminder of the protective layer. The carbonaceous material may be, for example, porous or non-porous. The carbonaceous material may be, for example in the form of particles. The carbonaceous material may include, for example, spherical particles (e.g., substantially spherical particles), plate-like particles, acicular particles, or any combination thereof. The particles of the carbonaceous material may have, for example, a non-substantially uniform shape. In one or more embodiments, an average particle diameter of the carbonaceous material (e.g., the amorphous carbon particles) may be for example, from 10 nm to 500 nm, from 10 nm to 300 nm, from 10 nm to 200 nm, from 10 nm to 100 nm, from 10 nm to 50 nm, from 30 nm to 50 nm, or from 40 nm to 50 nm. In the embodiments in which the carbonaceous material has the particle diameter within the above-described ranges, cycle characteristics of a lithium battery including the protective layer may further be improved. The particle diameter of the carbonaceous material may be measured, for example, by a laser diffraction method, a scanning electron microscope, a transmission electron microscope, or an atomic force microscope.

In one or more embodiments, the carbonaceous material may include, for example, carbon black, acetylene black, Denka black, Ketjen black, carbon nanotube, carbon nanofiber, carbon nanobelts, graphene, graphene oxide, fullerene, activated carbon, carbon fiber, or any combination thereof, but embodiments of the present disclosure are not limited thereto, and any materials commonly available as carbonaceous materials in the art may also be utilized.

In one or more embodiments, an amount of the carbonaceous material may be, for example, from 10 parts by weight to 100 parts by weight, from 30 parts by weight to 100 parts by weight, from 50 parts by weight to 100 parts by weight, or from 70 parts by weight to 90 parts by weight based on 100 parts by weight of the sulfurized polyacrylonitrile. In some embodiments, the amount of the carbonaceous material may be, for example, from 1 wt % to 50 wt %, from 10 wt % to 50 wt %, or from 20 wt % to 40 wt % based on the total weight of the protective layer. In the embodiments in which the amount of the carbonaceous material contained in the protective layer is within the above-described ranges, cycle characteristics of a lithium battery including the protective layer may further be improved.

For example, in one or more embodiments, the protective layer 23 may include 5 parts by weight to 40 parts by weight of the metal oxide and 50 to 100 parts by weight of the carbonaceous material based on 100 parts by weight of the sulfurized polyacrylonitrile. In the embodiments where the protective layer includes the above-described composition, cycle characteristics of a lithium battery including the protective layer may further be improved.

In one or more embodiments, the protective layer 23 may have, for example, a thickness of 1 μm to 50 μm, 3 μm to 20 μm, 5 μm to 20 μm, or 7 μm to 15 μm, but the thickness is not necessarily limited thereto and may vary according to required type or kind, capacity, and/or the like of the lithium battery. A too thin protective layer cannot perform the function of the protective layer. A too thick protective layer may cause an increase in internal resistance and thus energy density of the lithium battery may deteriorate.

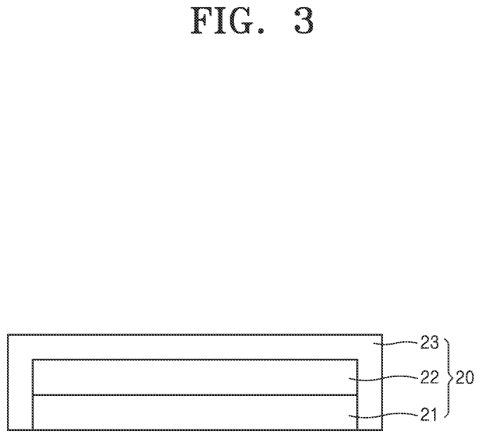

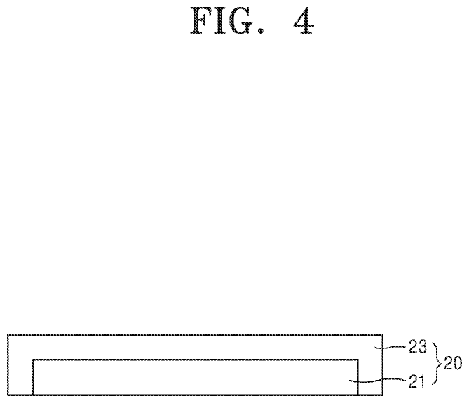

Referring to FIG. 3 and FIG. 4, in one or more embodiments, the protective layer 23 may be additionally disposed on side surfaces of the anode active material layer 22 and/or the anode current collector 21.

Referring to FIG. 3, in one or more embodiments, the anode 20 may include: an anode current collector 21; a protective layer 23 on the anode current collector 21; and an anode active material layer 22 between the anode current collector 21 and the protective layer 23, wherein the protective layer 23 may include sulfurized polyacrylonitrile SPAN, the anode active material layer 22 may include a lithium metal and/or a lithium alloy, and the protective layer 23 is disposed to extend to at least one side surface of the anode active material layer 22 and/or the anode current collector 21. The protective layer 23 completely covers the anode active material layer 22 and extends to the side surfaces of the anode current collector 21. The protective layer 23 may completely cover the side surfaces of the anode active material layer 22 and/or the anode current collector 21. Because the protective layer 23 extends to at least one side surface of the anode active material layer 22 and/or the anode current collector 21, the anode active material layer 22 may be protected more effectively.

Referring to FIG. 4, in one or more embodiments, the anode 20 may include an anode current collector 21; and a protective layer 23 on the anode current collector 21, wherein the protective layer 23 may include sulfurized polyacrylonitrile SPAN, and the protective layer 23 is disposed to extend to at least one side surface of the anode current collector 21. The protective layer 23 is disposed to extend to the side surfaces of the anode current collector 21. The protective layer 23 may completely cover the side surfaces of the anode current collector 21. Because the protective layer 23 extends to at least one side surface of the anode current collector 21, a lithium metal layer plated between the protective layer 23 and the anode current collector 21 may be more effectively protected.

### Anode: Anode Active Material Layer

Referring to FIG. 1 and FIG. 3, in one or more embodiments, the anode 20 for lithium metal batteries may include: an anode current collector 21; a protective layer 23 on the anode current collector 21; and an anode active material layer 22 between the anode current collector 21 and the protective layer 23, wherein the anode active material layer 22 may include lithium metal or a lithium alloy.

The anode active material layer 22 may include, for example, lithium foil, lithium powder, or any combination thereof. The lithium foil may include, for example, lithium metal foil, lithium alloy foil, or any combination thereof. The lithium powder may include lithium metal powder, lithium alloy powder, or any combination thereof. The lithium alloy is an alloy of lithium and a metal alloyable with lithium, for example, a lithium-silver alloy, a lithium-zinc alloy, a lithium-magnesium alloy, or a lithium-tin alloy. The anode active material layer including the lithium metal foil may be, for example, a lithium metal layer. The anode active material layer including the lithium alloy foil may be, for example, a lithium alloy layer. The anode active material layer including lithium metal powder and/or lithium alloy powder may be applied to the anode current collector by coating a slurry including lithium powder and/or lithium alloy powder and a binder thereon. The binder may be a fluorine-based binder, such as polyvinylidene fluoride (PVDF). The anode active material layer may not include (e.g., may exclude) a carbonaceous anode active material. Therefore, the anode active material layer may be formed of a metal-based anode active material.

In one or more embodiments, a thickness of the lithium foil may be, for example, from 1 μm to 50 μm, from 1 μm to 30 μm, from 10 μm to 30 μm, or from 10 μm to 80 μm. Because the thickness of the lithium foil is within the ranges described above, lifespan characteristics of a lithium battery including the protective layer may further be improved. In one or more embodiments, a particle diameter of the lithium powder may be, for example from 0.1 μm to 3 μm, from 0.1 μm to 2 μm, or from 0.1 μm to 2 μm. Because the particle diameter of the lithium powder is within the ranges described above, lifespan characteristics of the lithium battery including the protective layer may further be improved.

For example, in one or more embodiments, a thickness of the anode active material layer 22 may be from 0.1 μm to 100 μm, from 0.1 μm to 80 μm, from 1 μm to 80 μm, or from 10 μm to 80 μm, but is not limited thereto and may be adjusted according to required types (kinds), capacity, and/or the like of the lithium battery.

Referring to FIG. 2 and FIG. 4, in one or more embodiments, an anode active material layer is not disposed between the anode current collector 21 and the protective layer 23 in the anode 20. In the anode 20 in which the anode active material layer is not disposed, lithium metal is plated between the anode current collector 21 and the protective layer 23 by charging after the lithium metal is introduced into the lithium battery together with a cathode and an electrolyte. As a result, the anode 20 includes the anode active material layer. The anode active material layer may be a plated lithium layer.

### Anode: Anode Current Collector

Referring to FIGS. 1 to 4, in one or more embodiments, the anode 20 for lithium metal batteries includes the anode current collector 21.

The anode current collector 21 may include, for example, a first metal substrate. The first metal substrate may include a first metal as a main component or may include (e.g., consist of) the first metal. An amount of the first metal contained in the first metal substrate may be, for example, 90 wt % or more, 95 wt % or more, 99 wt % or more, or 99.9 wt % or more based on a total weight of the first metal substrate. The first metal substrate may be formed of, for example, a material that does not react with lithium, i.e., a material that does not form an alloy and/or compound with lithium. The first metal may be, for example, copper (Cu), nickel (Ni), stainless steel (SUS), iron (Fe), and/or cobalt (Co), but embodiments of the present disclosure are not necessarily limited thereto, and any materials commonly available in the art as current collectors may also be utilized. The first metal substrate may be formed of, for example, one metal selected from those described above or an alloy of two or more metals. The first metal substrate may be, for example, in the form of a sheet or foil. A thickness of the anode current collector 21 may be, for example, from 5 μm to 50 μm, from 10 μm to 50 μm, from 10 μm to 40 μm, or from 10 μm to 30 μm, but is not particularly limited thereto and may be selected according to required properties of the lithium battery.

In one or more embodiments, the anode current collector 21 may further include a coating layer including a second metal and formed on the first metal substrate.

For example, in some embodiments, the anode current collector 21 may include the first metal substrate and the coating layer disposed on the first metal substrate and including the second metal. The second metal has a higher Mohs hardness than that of the first metal. For example, because the coating layer including the second metal is harder than the substrate including the first metal, deterioration of the first metal substrate may be prevented or reduced. A Mohs hardness of a material constituting the first metal substrate may be, for example, 5.5 or less. The Mohs hardness of the first metal may have, for example, a Mohs hardness of 5.5 or less, 5.0 or less, 4.5 or less, 4.0 or less, 3.5 or less, or 3.0 or less. The Mohs hardness of the first metal may be, for example, from 2.0 to 6.0. The coating layer includes the second metal. For example, the coating layer may include the second metal as a main component or include (e.g., consist of) the second metal. An amount of the second metal contained in the coating layer may be, for example, 90 wt % or more, 95 wt % or more, 99 wt % or more, or 99.9 wt % or more based on a total weigh of the coating layer. The coating layer may be formed of, for example, a material that does not react with lithium, i.e., a material that does not form an alloy and/or compound with lithium. A Mohs hardness of the material constituting the coating layer is, for example, 6.0 or more. For example, the Mohs hardness of the second metal may be 6.0 or more, 6.5 or more, 7.0 or more, 7.5 or more, 8.0 or more, 8.5 or more, or 9.0 or more. The Mohs hardness of the second metal may be, for example, from 6.0 to 12. In the embodiments in which the Mohs hardness of the second metal is too low, deterioration of the anode current collector may not be inhibited. In the embodiments in which the Mohs hardness of the second metal is too high, processing may not be easy. For example, in one or more embodiments, the second metal may include at least one selected from titanium (Ti), manganese (Mn), niobium (Nb), tantalum (Ta), iridium (Ir), vanadium (V), rhenium (Re), osmium (Os), tungsten (W), chromium (Cr), boron (B), ruthenium (Ru), and rhodium (Rh). The coating layer may be formed of, for example, one of the metals described above or an alloy of at least two metals selected therefrom. A Mohs hardness different between the first metal included in the first metal substrate and the second metal included in the coating layer may be, for example, 2 or more, 2.5 or more, 3 or more, 3.5 or more, or 4 or more. Because the Mohs hardness difference between the first metal and the second metal is within the ranges described above, deterioration of the anode current collector may be more effectively inhibited. The coating layer may have a single-layer structure or a multilayer structure including two or more layers. For example, in some embodiments, the coating layer may have a double-layer structure including a first coating layer and a second coating layer. For example, in some embodiments, the coating layer may have a triple-layer structure including a first coating layer, a second coating layer, and a third coating layer. A thickness of the coating layer may be, for example, from 10 nm to 1 μm, from 50 nm to 500 nm, from 50 nm to 200 nm, or from 50 nm to 150 nm. In the embodiments in which the coating layer is too thin, it may be difficult to inhibit non-substantially uniform growth of the lithium-containing metal layer. As the thickness of the coating layer increases, cycle characteristics of the lithium battery are improved. However, in the embodiments in which the coating layer is too thick, energy density of the lithium battery decreases and formation of the coating layer may not be easy. The coating layer may be disposed on the first metal substrate by, for example, vacuum deposition, sputtering, or plating, but the method is not limited thereto, and any method of forming the coating layer commonly utilized in the art may also be utilized.

In one or more embodiments, the anode current collector 21 may include, for example, a base film and a metal layer disposed on one side or both (e.g., opposite) sides of the base film. The base film may include, for example, a polymer. The polymer may be, for example, a thermoplastic polymer. The polymer may be, for example, polyethyleneterephthalate (PET), polyethylene (PE), polypropylene (PP), polybutyleneterephthalate (PBT), polyimide (PI), or any combination thereof. The polymer may be an insulating polymer. Because the base film includes an insulating thermoplastic polymer, the base film is softened or liquefied to block or reduce the operation of a battery in the case of occurrence of a short circuit, so that a rapid current increase may be inhibited. The metal layer may include, for example, copper (Cu), stainless steel, titanium (Ti), iron (Fe), cobalt (Co), nickel (Ni), or an alloy thereof. The metal layer may correspond to, for example, the first metal substrate. The metal layer may further include a coating layer including the second metal. In one or more embodiments, the anode current collector 21 may further include a metal chip and/or a lead tab. For more detailed descriptions of the base film, the metal layer, the metal chip, and the lead tab of the anode current collector 21, the reference may refer to the description of a cathode current collector. Because the anode current collector 21 has the above-described structure, the weight of the anode may be reduced, and accordingly, energy density of the anode and the lithium battery may be increased.

### Anode: Anode Interlayer

Referring to FIG. 1 and FIG. 3, in one or more embodiments, the anode 20 for lithium metal batteries may optionally further include an anode interlayer between the protective layer 23 and the anode active material layer 22. Referring to FIG. 2 and FIG. 4, in one or more embodiments, the anode 20 may optionally further include an anode interlayer between the protective layer 23 and the anode current collector 21. Because the anode 20 further includes the anode interlayer, formation or growth of lithium dendrites may be more effectively inhibited in the anode 20. In one or more embodiments, the anode interlayer may not be provided.

The anode interlayer may include, for example, an anode active material and a binder. The anode active material is an anode material allowing lithiation and delithiation. The anode active material contained in the anode interlayer may be, for example, in the form of particles. The anode active material in the form of particles may have an average particle diameter of, for example, 10 nm to 4 μm, 10 nm to 1 μm, 10 nm to 500 nm, 10 nm to 100 nm, or 20 nm to 80 nm. Because the average particle diameter of the anode active material is within the ranges described above, reversible plating and/or dissolution of lithium may occur more easily during a charge/discharge process. The average particle diameter of the anode active material is, for example, a median diameter D50 measured utilizing a laser particle size analyzer.

The anode active material contained in the anode interlayer may include, for example, at least one selected from among a carbonaceous anode active material and a metal or metalloid anode active material. The carbonaceous anode active material may be, for example, amorphous carbon. The carbonaceous anode active material may be, for example, carbon black (CB), acetylene black (AB), furnace black (FB), Ketjen black (KB), and/or graphene, but embodiments of the present disclosure are not limited thereto, and any carbonaceous materials classified into amorphous carbon may also be utilized. Amorphous carbon is carbon that does not have crystallinity or has very low crystallinity and is distinguished from crystalline carbon or graphite-based carbon. The metal or metalloid anode active material may include at least one selected from gold (Au), platinum (Pt), palladium (Pd), silicon (Si), silver (Ag), aluminum (Al), bismuth (Bi), tin (Sn), and zinc (Zn), but embodiments of the present disclosure are not limited thereto, and any suitable metal anode active materials and/or metalloid anode active materials capable of forming an alloy or compound with lithium may also be utilized. For example, because nickel (Ni) does not form an alloy with lithium, Ni is not a metal anode active material. The anode interlayer may include one of these anode active materials or a mixture of a plurality of different anode active materials. In one or more embodiments, the anode interlayer may include, for example, a mixture of amorphous carbon with at least one of gold (Au), platinum (Pt), palladium (Pd), silicon (Si), silver (Ag), aluminum (Al), bismuth (Bi), tin (Sn), or zinc (Zn). A mixing ratio of the mixture may be, for example, from 10:1 to 1:2, from 10:1 to 1:1, from 7:1 to 1:1, from 5:1 to 1:1, or from 4:1 to 2:1. For example, in one or more embodiments, the anode active material included in the anode interlayer may include a mixture of first particles formed of amorphous carbon and second particles formed of a metal or metalloid. The metal may include, for example, at least one of gold (Au), platinum (Pt), palladium (Pd), silicon (Si), silver (Ag), aluminum (Al), bismuth (Bi), tin (Sn), or zinc (Zn). An amount of the second particles may be from 8 wt % to 60 wt %, from 10 wt % to 50 wt %, from 15 wt % to 40 wt %, or from 20 wt % to 30 wt % based on a total weight of the mixture. In the embodiments in which the amount of the second particles is within the ranges described above, cycle characteristics of the lithium battery may further be improved.

The binder included in the anode interlayer may be, for example, styrene butadiene rubber (SBR), polytetrafluoroethylene, polyvinylidene fluoride, polyethylene, a vinylidene fluoride/hexafluoropropylene copolymer, polyacrylonitrile, or polymethylmethacrylate, but embodiments of the present disclosure are not limited thereto, and any binders commonly available in the art may also be utilized. The binder may be utilized alone or in combination of a plurality of different binders. In the embodiments in which the anode interlayer does not include a binder, the anode interlayer may be easily separated from the protective layer 23 and/or from the anode current collector 21. In one or more embodiments, an amount of the binder included in the anode interlayer is, for example, from 1 wt % to 20 wt % based on a total weight of the anode interlayer.

In one or more embodiments, a thickness of the anode interlayer may be, for example, from 1 μm to 20 μm, from 1 μm to 15 μm, from 2 μm to 10 μm, or from 3 μm to 7 μm. In some embodiments, the thickness of the anode interlayer may be, for example, from 1% to 50%, from 1% to 30%, from 1% to 10%, or from 1% to 5% based on a thickness of the cathode active material layer. In the embodiments in which the anode interlayer is too thin, lithium dendrites formed between the anode interlayer and the anode current collector disintegrate the anode interlayer, making it difficult to improve cycle characteristics of the lithium battery. In the embodiments in which the anode interlayer is too thick, energy density of the lithium battery including the anode 20 decreases, making it difficult to improve cycle characteristics of thereof. Also, as the thickness of the anode interlayer decreases, for example, a charging capacity of the anode interlayer also decreases. The charging capacity of the anode interlayer may be, for example, from 0.1% to 50%, from 1% to 30%, from 1% to 10%, from 1% to 5%, or from 1% to 2% based on a total charging capacity of the cathode active material layer. In the embodiments in which the charging capacity of the anode interlayer is too low, lithium dendrites formed between the anode interlayer and the anode current collector disintegrate the anode interlayer making it difficult to improve cycle characteristics of the lithium battery. In the embodiments in which the charging capacity of the anode interlayer is too high, energy density of the lithium battery including the anode 20 decreases, making it difficult to improve cycle characteristics. The charging capacity of the cathode active material layer is obtained by multiplying a charging capacity density (mAh/g) of the cathode active material by a mass of the cathode active material of the cathode active material layer. If one or more suitable types (kinds) of cathode active materials are utilized, charging capacity density×mass values for all of the cathode active materials are calculated respectively, and a sum of the values is regarded as the total charging capacity of the cathode active material layer. The charging capacity of the anode interlayer is calculated in substantially the same manner. For example, the charging capacity of the anode interlayer is obtained by multiplying a charging capacity density (mAh/g) of the anode active material by a mass of the anode active material of the anode interlayer. If one or more suitable types (kinds) of anode active materials are utilized, charging capacity density×mass values for all of the anode active materials are respectively calculated and a sum of the values is regarded as the charging capacity of the anode interlayer. In this case, the charging capacity densities of the cathode active material and the anode active material are capacities estimated utilizing all-solid half-cells to which lithium metal is applied as a counter electrode. The charging capacities of the cathode active material layer and the anode interlayer are directly measured utilizing the all-solid half-cells. The charging capacity density is calculated by dividing the measured charging capacity by the mass of each active material. In some embodiments, a charging capacity of the cathode active material layer and the anode interlayer may be initial charging capacity measured during charging of a first cycle.

### Lithium Metal Battery

A lithium metal battery according to one or more embodiments may include: a cathode; the above-described anode; and an electrolyte between the cathode and the anode, wherein the anode may include a lithium metal and/or a lithium alloy. The lithium metal battery may have increased capacity and excellent or suitable lifespan characteristics by including the above-described anode. The lithium metal battery may be, for example, a lithium primary battery, a lithium secondary battery, a lithium-sulfur battery, or a lithium-air battery, but embodiments of the present disclosure are not limited thereto, and any lithium metal batteries commonly available in the art may also be utilized.

Although the lithium metal battery is prepared, for example, by the following example method, the method is not limited thereto and may be adjusted according to required conditions.

### Anode

The above-described anode including a lithium metal and/or a lithium alloy may be prepared.

### Cathode

First, a cathode active material composition may be prepared by mixing a cathode active material, a conductive material, a binder, and a solvent. The prepared cathode active material composition may be directly coated on an aluminum current collector (as a cathode current collector) and dried to prepare a cathode plate on which a cathode active material layer is formed. In some embodiments, a cathode plate on which a cathode active material layer is formed is prepared by casting the cathode active material composition on a separate support and laminating a film separated from the support on an aluminum current collector.

The cathode active material may be any lithium-containing metal oxide commonly utilized in the art without limitation. For example, in one or more embodiments, the cathode active material may include at least one composite oxide of lithium and a metal selected from cobalt, manganese, nickel, and any combination thereof, and non-limiting examples thereof may be a compound represented by one of the following formulae: LiₐA_{1-b}B_{b}D₂ (where 0.90≤a≤1 and 0≤b≤0.5); LiₐE_{1-b}B_{b}O_{2-c}D_{c} (where 0.90≤a≤1, 0≤b≤0.5 and 0≤c≤0.05); LiE_{2-b}B_{b}O_{4-c}D_{c} (where 0≤b≤0.5 and 0≤c≤0.05); LiₐNi_{1-b-c}Co_{b}B_{c}D_{α} (where 0.90≤a≤1, 0≤b≤0.5, 0≤c≤0.05 and 0≤a≤2); LiₐNi_{1-b-c}Co_{b}B_{c}O₂₋ₐFₐ (where 0.90≤a≤1, 0≤b≤0.5, 0≤c≤0.05 and 0<α<2); LiₐNi_{1-b-c}Co_{b}B_{c}O_{2-α}F₂ (where 0.90≤a≤1, 0≤b≤0.5, 0≤c≤0.05 and 0<α<2); LiₐNi_{1-b-c}Mn_{b}B_{c}D_{α} (where 0.90≤a≤1, 0≤b≤0.5, 0≤c≤0.05 and 0<α≤2); LiₐNi_{1-b-c}Mn_{b}B_{c}O_{2-α}F_{α} (where 0.90≤a≤1, 0≤b≤0.5, 0≤c≤0.05 and 0<α<2); LiₐNi_{1-b-c}Mn_{b}B_{c}O_{2-α}F₂ (where 0.90≤a≤1, 0≤b≤0.5, 0≤c≤0.05 and 0<α<2); LiₐNi_{b}E_{c}G_{d}O₂ (where 0.90≤a≤1, 0≤b≤0.9, 0≤c≤0.5 and 0.001≤d≤0.1); LiₐNi_{b}Co_{c}Mn_{d}GₑO₂ (where 0.90≤a≤1, 0≤b≤0.9, 0≤c≤0.5, 0≤d≤0.5 and 0.001≤e≤0.1); LiₐNiG_{b}O₂ (where 0.90≤a≤1 and 0.001≤b≤0.1); LiₐCoG_{b}O₂ (where 0.90≤a≤1 and 0.001≤b≤0.1); LiₐMnG_{b}O₂ (where 0.90≤a≤1 and 0.001≤b≤0.1); LiₐMn₂G_{b}O₄ (where 0.90≤a≤1 and 0.001≤b≤0.1); QO₂; QS₂; LiQS₂; V₂O₅; LiV₂O₅; LiIO₂; LiNiVO₄; Li_{(3-f)}J₂(PO₄)₃ (where 0≤f≤2); Li_{(3-f)}Fe₂(PO₄)₃ (where 0≤f≤2); and LiFePO₄.

In the formulae representing compounds above, A is Ni, Co, Mn, or any combination thereof; B is Al, Ni, Co, Mn, Cr, Fe, Mg, Sr, V, a rare earth element, or any combination thereof; D is 0, F, S, P, or any combination thereof; E is Co, Mn, or any combination thereof; F is F, S, P, or any combination thereof; G is Al, Cr, Mn, Fe, Mg, La, Ce, Sr, V, or any combination thereof; Q is Ti, Mo, Mn, or any combination thereof; I is Cr, V, Fe, Sc, Y, or any combination thereof; and J is V, Cr, Mn, Co, Ni, Cu, or any combination thereof. In some embodiments, the above-described compound having a coating layer on the surface thereof may be utilized or a mixture of the above-described compound and a compound having a coating layer may also be utilized. The coating layer added to the surface of the compound may include, for example, a compound of a coating element such as an oxide, a hydroxide, an oxyhydroxide, an oxycarbonate, or a hydroxycarbonate of the coating element. The compound constituting the coating layer is amorphous or crystalline. The coating element included in the coating layer may be Mg, Al, Co, K, Na, Ca, Si, Ti, V, Sn, Ge, Ga, B, As, Zr, or any mixture thereof. A method of forming the coating layer may be selected from those not adversely affect physical properties of the cathode active material. The coating methods may be, for example, spray coating and dip coating. These methods are obvious to those of ordinary skill in the art, and thus detailed descriptions thereof will not be given for conciseness.

In one or more embodiments, the cathode active material may be, for example, LiₐNiₓCo_{y}M_{z}O_{2-b}A_{b} (where 1.0≤a≤1.2, 0≤b≤0.2, 0.8≤x<1, 0<y≤0.3, 0<z≤0.3, x+y+z=1, M is manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or any combination thereof, and A is fluorine (F), sulfur (S), chlorine (Cl), bromine (Br), or any combination thereof), LiNiₓCo_{y}Mn_{z}O₂ (where 0.8≤x≤0.95, 0≤y≤0.2, 0<z≤0.2 and x+y+z=1), LiNiₓCo_{y}Al_{z}O₂ (where 0.8≤x≤0.95, 0≤y≤0.2, 0<z≤0.2, and x+y+z=1), LiNiₓCo_{y}Mn_{z}Al_{w}OZ (where 0.8≤x≤0.95, 0≤y≤0.2, 0<z≤0.2, 0<w≤0.2, and x+y+z+w=1), LiₐCoₓM_{y}O_{2-b}A_{b} (where 1.0≤a≤1.2, 0≤b≤0.2, 0.9≤x≤1, 0≤y≤0.1, x+y=1, M is manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or any combination thereof, and A is F, S, Cl, Br, or any combination thereof), LiₐNiₓMn_{y}M′_{z}O_{2-b}A_{b} (where 1.0≤a≤1.2, 0≤b≤0.2, 0<x≤0.3, 0.5≤y<1, 0<z≤0.3, x+y+z=1, M′ is cobalt (Co), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or any combination thereof, and A is F, S, Cl, Br, or any combination thereof), LiₐM1ₓM2_{y}PO_{4-b}X_{b} (where 0.90≤a≤1.1, 0≤x≤0.9, 0≤y≤0.5, 0.9<x+y<1.1, 0≤b≤2, M1 is chromium (Cr), manganese (Mn), iron (Fe), cobalt (Co), nickel (Ni), copper (Cu), zirconium (Zr), or any combination thereof, M2 is magnesium (Mg), calcium (Ca), strontium (Sr), barium (Ba), titanium (Ti), zinc (Zn), boron (B), niobium (Nb), gallium (Ga), indium (In), molybdenum (Mo), tungsten (W), aluminum (Al), silicon (Si), chromium (Cr), vanadium (V), scandium (Sc), yttrium (Y), or any combination thereof, and X is O, F, S, P, or any combination thereof), and/or LiₐM3_{z}PO₄ (where 0.90≤a≤1.1, 0.9≤z≤1.1, and M3 is chromium (Cr), manganese (Mn), iron (Fe), cobalt (Co), nickel (Ni), copper (Cu), zirconium (Zr), or any combination thereof).

The conductive material may be carbon black, graphite particulates, natural graphite, artificial graphite, acetylene black, Ketjen black, carbon fiber; carbon nanotubes; metal such as copper, nickel, aluminum, and silver, each of which may be utilized in powder, fiber, or tube form; and/or conductive polymers such as polyphenylene derivatives, but embodiments of the present disclosure are not limited thereto, and any material commonly utilized in the art as conductive materials may also be utilized. In some embodiments, the cathode may not include (e.g., may exclude) a separate conductive material.

The binder may be a vinylidene fluoride/hexafluoropropylene copolymer, polyvinylidene fluoride, polyacrylonitrile, polymethylmethacrylate, polytetrafluoroethylene (PTFE), a mixture thereof, and/or a styrene butadiene rubber polymer. The solvent may be N-methylpyrrolidone (NMP), acetone, and water, but embodiments of the present disclosure are not limited thereto, and any solvent commonly utilized in the art may also be utilized.

In one or more embodiments, a plasticizer or a pore forming agent may further be added to the cathode active material composition to form pores inside the electrode plate.

Amounts of the cathode active material, the conductive material, the binder, and the solvent may be the same levels as those commonly utilized in lithium batteries. In some embodiments, at least one of the conductive material, the binder, or the solvent may not be provided in accordance with a utilization and a configuration of the lithium battery.

In one or more embodiments, an amount of the binder included in the cathode may be, for example, from 0.1 wt % to 10 wt % or from 0.1 wt % to 5 wt % based on a total weight of the cathode active material layer. An amount of the cathode active material included in the cathode may be, for example, from 80 wt % to 99 wt %, from 90 wt % to 99 wt %, or from 95 wt % to 99 wt % based on the total weight of the cathode active material layer.

The cathode current collector may be formed of, for example, indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or any alloy thereof in the form of a plate, foil, and/or the like. The cathode current collector may have a thickness of, for example, 1 μm to 100 μm, 1 μm to 50 μm, 5 μm to 25 μm, or 10 μm to 20 μm.

In one or more embodiments, the cathode current collector may include, for example, a base film and a metal layer disposed on one side or both (e.g., simultaneously) sides of the base film. The base film may include, for example, a polymer. The polymer may be, for example, a thermoplastic polymer. The polymer may be, for example, polyethyleneterephthalate (PET), polyethylene (PE), polypropylene (PP), polybutyleneterephthalate (PBT), polyimide (PI), or any combination thereof. The polymer may be an insulator. Because the base film includes an insulating thermoplastic polymer, the base film is softened or liquefied to block or reduce the operation of a battery in the case of occurrence of a short circuit, so that a rapid current increase may be inhibited. The metal layer may include, for example, indium (In), copper (Cu), magnesium (Mg), stainless steel, titanium (Ti), iron (Fe), cobalt (Co), nickel (Ni), zinc (Zn), aluminum (Al), germanium (Ge), or any alloy thereof. The metal layer may act as an electrochemical fuse and is cut by an overcurrent, thereby preventing or reducing a short circuit. By controlling a thickness of the metal layer, a limiting current and a maximum current may be adjusted. The metal layer may be plated or deposited on the base film. As the thickness of the metal layer decreases, the limiting current and/or maximum current of the cathode current collector decrease, so that stability of the lithium battery may be improved in the case of a short circuit. In one or more embodiments, a lead tab may be added onto the metal layer for connection with the outside. The lead tab may be welded to the metal layer or a metal layer/base film stack structure by ultrasonic welding, laser welding, spot welding, and/or the like. While the base film and/or the metal layer melts during welding, the metal layer may be electrically connected to the lead tab. In one or more embodiments, a metal chip may further be added between the metal layer and the lead tab for stronger welding between the metal layer and the lead tab. The metal chip may be a chip of the same material as the metal of the metal layer. The metal chip may be, for example, metal foil and/or metal mesh. The metal chip may be, for example, aluminum foil, copper foil, and/or stainless steel (SUS) foil. By performing welding after disposing the metal chip on the metal layer, the lead tab may be welded to the metal chip/metal layer stack structure or the metal chip/metal layer/base film stack structure. While the base film, the metal layer, and/or the metal chip melt during welding, the metal layer or metal layer/metal chip stack structure may be electrically connected to the lead tab. In one or more embodiments, a metal chip and/or a lead tab may further be added to the metal layer. The base film may have a thickness of, for example, 1 μm to 50 μm, 1.5 μm to 50 μm, 1.5 μm to 40 μm, or 1 to 30 μm. With the thickness of the base film within the above-described ranges, the weight of the electrode assembly may be more effectively reduced. A melting point of the base film may be, for example, from 100° C. to 300° C., from 100° C. to 250° C., or from 100° C. to 200° C. Because the base film has a melting point within the above-described ranges, the base film melts during a process of welding the lead tab to be easily bound to the lead tab. To improve adhesion between the base film and the metal layer, surface treatment such as corona treatment may be performed on the base film. A thickness of the metal layer may be, for example, from 0.01 μm to 3 μm, from 0.1 μm to 3 μm, from 0.1 μm to 2 μm, or from 0.1 μm to 1 μm. With the thickness of the metal layer within the above-described ranges, stability of the electrode assembly may be obtained while maintaining conductivity thereof. A thickness of the metal chip may be, for example, from 2 μm to 10 μm, from 2 μm to 7 μm, or from 4 μm to 6 μm. With the thickness of the metal chip within the above-described ranges, the metal layer may be more easily connected to the lead tab. Because the cathode current collector has the above-described structure, the weight of the cathode may be reduced, so that energy density of the cathode and the lithium battery may be increased.

### Separator

Subsequently, a separator to be inserted between the positive electrode and the negative electrode may be prepared.

Any separator commonly utilized in the art for lithium batteries may be utilized. For example, any separator having low resistance to ion migration of the electrolyte and excellent or suitable electrolyte-retaining ability may be utilized. For example, the separator may be selected from glass fiber, polyester, Teflon, polyethylene, polypropylene, polytetrafluoroethylene (PTFE), or any combination thereof, each of which may be a non-woven or woven fabric. For example, in some embodiments, a windable separator such as polyethylene or polypropylene may be utilized in lithium-ion batteries, and a separator having excellent or suitable organic electrolyte-retaining ability may be utilized in lithium-ion polymer batteries.

The separator may be prepared according to the following example method. However, the method is not limited thereto and may be adjusted according to required conditions.

First, a polymer resin, a filler, and a solvent are mixed to prepare a separator composition. The separator composition may be directly coated on an electrode and dried to prepare a separator. In some embodiments, the separator composition is cast on a support and dried and then a separator film separated from the support is laminated on an electrode to form a separator.

The polymer utilized to prepare the separator is not particularly limited, and any polymer commonly utilized as a binder for electrode plates may also be utilized. For example, a vinylidene fluoride/hexafluoropropylene copolymer, polyvinylidenefluoride (PVDF), polyacrylonitrile, polymethylmethacrylate, or any mixture thereof may be utilized.

### Electrolyte

Subsequently, an electrolyte may be prepared. The electrolyte may be, for example, a liquid electrolyte, a solid electrolyte, a gel electrolyte, or any combination thereof. For example, in some embodiments, the electrolyte may be an organic electrolytic solution. The electrolytic solution is prepared, for example, by dissolving a lithium salt in an organic solvent.

Any organic solvent commonly utilized in the art may be utilized. For example, in one or more embodiments, the organic solvent may be propylene carbonate, ethylene carbonate, fluoroethylene carbonate, butylene carbonate, dimethyl carbonate, diethyl carbonate, methylethyl carbonate, methylpropyl carbonate, ethylpropyl carbonate, methylisopropyl carbonate, dipropyl carbonate, dibutyl carbonate, benzonitrile, acetonitrile, tetrahydrofuran, 2-methyltetrahydrofuran, γ-butyrolactone, dioxorane, 4-methyldioxorane, N,N-dimethyl formamide, dimethyl acetamide, dimethylsulfoxide, dioxane, 1,2-dimethoxyethane, sulfolane, dichloroethane, chlorobenzene, nitrobenzene, diethylene glycol, dimethyl ether, or any mixture thereof.

The lithium salt may also be any lithium salt commonly utilized in the art. For example, in one or more embodiments, the lithium salt may be LiPFe, LiBF₄, LiSbFe, LiAsFe, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (where 1≤x≤20 and 1≤y≤20), LiCl, LiI, or any mixture thereof. A concentration of the lithium salt may be, for example, from 0.1 M to 5.0 M.

The solid electrolyte may be, for example, an oxide-based solid electrolyte, a sulfide-based solid electrolyte, a polymer solid electrolyte, or any combination thereof.

In one or more embodiments, the solid electrolyte may be, for example, an oxide-based solid electrolyte. The oxide-based solid electrolyte may include, for example, at least one selected from Li_{1+x+y}AlₓTi₂₋ₓSi_{y}P_{3-y}O₁₂ (where 0<x<2 and 0≤y≤3), BaTiO₃, Pb(Zr,Ti)O₃ (PZT), Pb₁₋ₓLaₓZr_{1-y}Ti_{y}O₃ (PLZT, where 0≤x<1 and 0≤y≤1), Pb(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LixTiy(PO₄)₃ (where 0<x<2 and 0<y<3), LiₓAl_{y}Ti_{z}(PO₄)₃ (where 0<x<2, 0<y<1, and 0<z<3), Li_{1+x+y}(Al,Ga)ₓ(Ti,Ge)₂₋ₓSi_{y}P_{3-y}O₁₂ (where 0≤x≤1 and 0≤y≤1), LiₓLa_{y}TiO₃ (where 0<x<2 and 0<y<3), Li₂O, LiOH, Li₂CO₃, LiAlO₂, Li₂O—Al₂O₃—SiO₂—P₂O₅—TiO₂—GeO₂, and Li₃₊ₓLa₃M₂O₁₂ (where M=Te, Nb, or Zr, and x is an integer from 1 to 10). The solid electrolyte may be manufactured by a sintering method, and/or the like. For example, in some embodiments, the oxide-based solid electrolyte is a Garnet-type or kind solid electrolyte selected from Li₇La₃Zr₂O₁₂ (LLZO) and Li₃₊ₓLa₃Zr₂₋ₐMₐO₁₂ (M doped LLZO, where M=Ga, W, Nb, Ta, or Al and x is an integer from 1 to 10).

For example, in one or more embodiments, the sulfide-based solid electrolyte may include at least one selected from lithium sulfide, silicon sulfide, phosphorous sulfide, boron sulfide, and/or any combination thereof, for example, in a form of particles. In some embodiments, the sulfide-based solid electrolyte particles may include Li₂S, P₂S₅, SiS₂, GeS₂, B₂S₃, or any combination thereof. In some embodiments, the sulfide-based solid electrolyte particles may be Li₂S and/or P₂S₅. Sulfide-based solid electrolyte particles are suitable to have higher lithium ion conductivity than other inorganic compounds. For example, in some embodiments, the sulfide-based solid electrolyte may include Li₂S and P₂S₅. In the embodiments in which a sulfide solid electrolyte material constituting the sulfide-based solid electrolyte includes Li₂S—P₂S₅, a mixing molar ratio of Li₂S to P₂S₅ may be, for example, in the range of 50:50 to 90:10. In some embodiments, an inorganic solid electrolyte prepared by adding Li₃PO₄, a halogen, a halogen compound, Li₂₊₂ₓZn₁₋ₓGeO₄ (“LISICON”, where 0≤x<1), Li_{3+y}PO₄₋ₓNₓ (“LIPON”, where 0<x<4 and 0<y<3), Li_{3.25}Ge_{0.25}P_{0.75}S₄ (“Thio-LISICON”), Li₂O—Al₂O₃—TiO₂—P₂O₅ (“LATP”), and/or the like to an inorganic solid electrolyte such as Li₂S—P₂S₅, SiS₂, GeS₂, B₂S₃, or any combination thereof may be utilized as a sulfide-based solid electrolyte. Non-limiting examples of the sulfide-based solid electrolyte material may include, but are not limited to, Li₂S—P₂S₅; Li₂S—P₂S₅—LiX (where X is a halogen atom); Li₂S—P₂S₅—Li₂O; Li₂S—P₂S₅—Li₂O—LiI; Li₂S—SiS₂; Li₂S—SiS₂—LiI; Li₂S—SiS₂—LiBr; Li₂S—SiS₂—LiCl; Li₂S—SiS₂—B₂S₃—LiI; Li₂S—SiS₂—P₂S₅—LiI; Li₂S—B₂S₃; Li₂S—P₂S₅—ZₘSₙ (where 0<m<10, 0<n<10, and Z═Ge, Zn or Ga); Li₂S—GeS₂; Li₂S—SiS₂—Li₃PO₄; and/or Li₂S—SiS₂—LiₚMO_{q} (where 0<p<10, 0<q<10, and M is P, Si, Ge, B, Al, Ga, or In). In this regard, the sulfide-based solid electrolyte material may be manufactured by treating starting materials (e.g., Li₂S and P₂S₅) of the sulfide-based solid electrolyte by a melt quenching method, a mechanical milling method, and/or the like. Also, in some embodiments, a calcination process may further be performed after the above process. The sulfide-based solid electrolyte may be in an amorphous or crystalline form or in a mixed form thereof.

The polymer solid electrolyte may include, for example, a mixture of a lithium salt and a polymer or a polymer having an ion-conductive functional group. The polymer solid electrolyte may be, for example, a polymer electrolyte in a solid state at 25° C. and 1 atm. For example, in some embodiments, the polymer solid electrolyte may not include (e.g., may exclude) a liquid. The polymer solid electrolyte includes a polymer, and non-limiting examples of the polymer may include polyethyleneoxide (PEO), polyvinylidenefluoride (PVDF), vinylidene fluoride-hexafluoropropylene (PVDF-HFP), poly(styrene-b-ethylene oxide) block copolymer (PS—PEO), poly(styrene-butadiene), poly(styrene-isoprene-styrene), poly(styrene-b-divinylbenzene) block copolymer, poly(styrene-ethylene oxide-styrene) block copolymer, polystyrene sulfonate (PSS), polyvinyl fluoride (PVF), poly(methylmethacrylate) (PMMA), polyethylene glycol (PEG), polyacrylonitrile (PAN), polytetrafluoroethylene (PTFE), polyethylenedioxythiophene (PEDOT), polypyrrole (PPY), polyaniline, polyacetylene, Nafion, Aquivion, Flemion, Gore, Aciplex, Morgane ADP, sulfonated poly(ether ether ketone) (SPEEK), sulfonated poly(arylene ether ketone ketone sulfone) (SPAEKKS), sulfonated poly(aryl ether ketone (SPAEK), poly[bis(benzimidazobenzisoquinolinones)](SPBIBI), poly(styrene sulfonate) (PSS), lithium 9,10-diphenylanthracene-2-sulfonate (DPASLi+), or any combination thereof. However, the embodiments of the present disclosure are not limited thereto, and any polymer electrolytes commonly available in the art may also be utilized. Any lithium salts commonly available in the art may also be utilized. Non-limiting examples of the lithium salt may include LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ+1 SO₂)(C_{y}F_{2y}+1 SO₂) (where x and y may each independently be from 1 to 20), LiCl, LiI, or any mixture thereof. The polymer included in the polymer solid electrolyte may be, for example, a compound including 10 or more, 20 or more, 50 or more, or 100 or more repeating units. A weight average molecular weight of the polymer included in the polymer solid electrolyte may be, for example, 1000 Dalton (Da) or more, 10,000 Da or more, 100,000 Da or more, or 1,000,000 Da or more.

The gel electrolyte may be, for example, a polymer gel electrolyte. For example, in some embodiments, the gel electrolyte may have a gel state without including a polymer.

The polymer gel electrolyte may include, for example, a liquid electrolyte and a polymer, or an organic solvent and a polymer having an ion-conductive functional group. The polymer gel electrolyte may be, for example, a polymer electrolyte in a gel state at 25° C. and 1 atm. In one or more embodiments, the polymer gel electrolyte may have, for example, a gel state without including a liquid. The liquid electrolyte utilized in the polymer gel electrolyte may be, for example, a mixture of an ionic liquid, a lithium salt, and an organic solvent; a mixture of a lithium salt and an organic solvent; a mixture of an ionic liquid and an organic solvent; or a mixture of a lithium salt, an ionic liquid, and an organic solvent. The polymer utilized in the polymer gel electrolyte may be selected from polymers utilized in the polymer solid electrolyte. The organic solvent may be selected from organic solvents utilized in liquid electrolytes. The lithium salt may be selected from lithium salts utilized in polymer solid electrolyte. The ionic liquid refers to a salt in a liquid state, and/or a molten salt at room temperature composed solely of ions and having a melting point below room temperature. The ionic liquid may include, for example: at least one compound including a) at least one cation selected from ammonium, pyrimidium, pyridinium, imidazolium, piperidinium, pyrazolium, oxazolium, pyridazinium, phosphonium, sulfonium, triazole, and any mixture thereof; and b) at least one anion selected from BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I, BF₄⁻, SO₄₂⁻, CF₃SO₃, (FSO₂)₂N⁻, (C₂F₅SO₂)₂N⁻, (C₂F₅SO₂)(CF₃SO₂)N⁻, and (CF₃SO₂)₂N⁻. For example, the polymer solid electrolyte may be impregnated with a liquid electrolyte in a secondary battery to form a polymer gel electrolyte. In some embodiments, the polymer gel electrolyte may further include inorganic particles. The polymer included in the polymer gel electrolyte may be a compound including, for example, 10 or more, 20 or more, 50 or more, or 100 or more repeating units. A weight average molecular weight of the polymer included in the polymer gel electrolyte may be, for example, 500 Da or more, 1000 Da or more, 10,000 Da or more, 100,000 Da or more, or 1,000,000 Da or more.

### Lithium Metal Battery

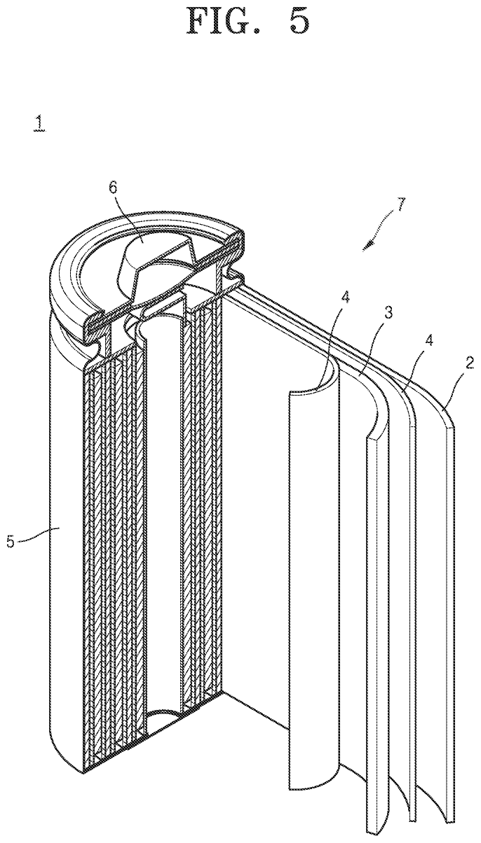

Referring to FIG. 5, a lithium metal battery 1 according to one or more embodiments may include a cathode 3, the above-described anode 2, and a separator 4. The cathode 3, the anode 2, and the separator 4 may be wound or folded to form a battery assembly 7. The formed battery assembly 7 is accommodated in a battery case 5. An organic electrolytic solution is injected into the battery case 5 and the battery case 5 is sealed with a cap assembly 6 to complete preparation of the lithium metal battery 1. The battery case 5 may be a cylindrical type or kind, but is not limited thereto and, for example, in some embodiments, a rectangular type or kind or a thin film type or kind may also be utilized.

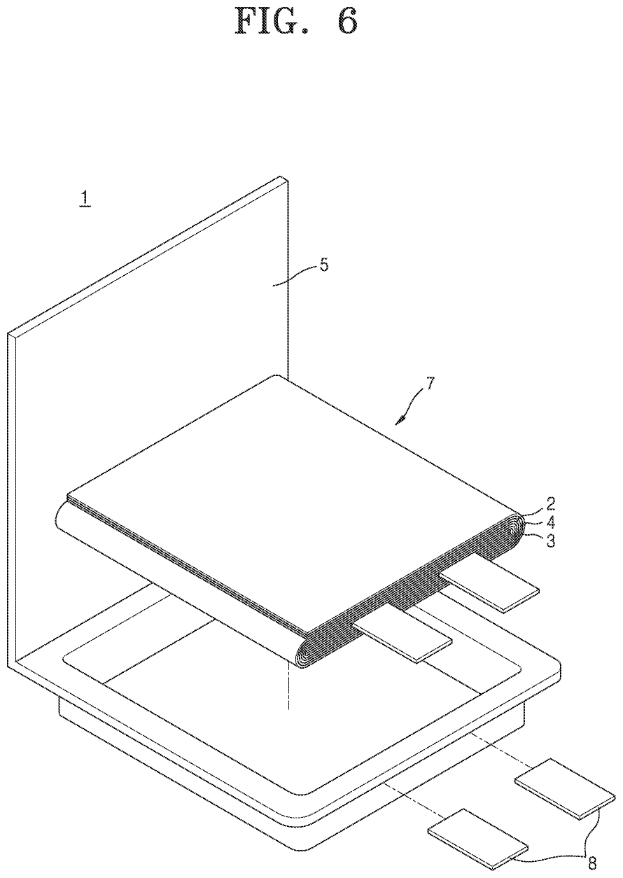

Referring to FIG. 6, a lithium metal battery 1 according to one or more embodiments may include a cathode 3, the above-described anode 2, and a separator 4. The separator 4 is disposed between the cathode 3 and the anode 2, and the cathode 3, the anode 2, and the separator 4 may be wound or folded to form a battery assembly 7. The formed battery assembly 7 is accommodated in a battery case 5. The lithium metal battery 1 may include an electrode tab 8 serving as an electrical passage for inducing a current generated in the battery assembly 7 to the outside. An organic electrolytic solution is injected into the battery case 5, and the battery case 5 is sealed to complete preparation of the lithium battery 1. The battery case 5 may be a rectangular type or kind, but is not limited thereto, and for example, in some embodiments, a cylindrical type or kind or a thin film type or kind may also be utilized.

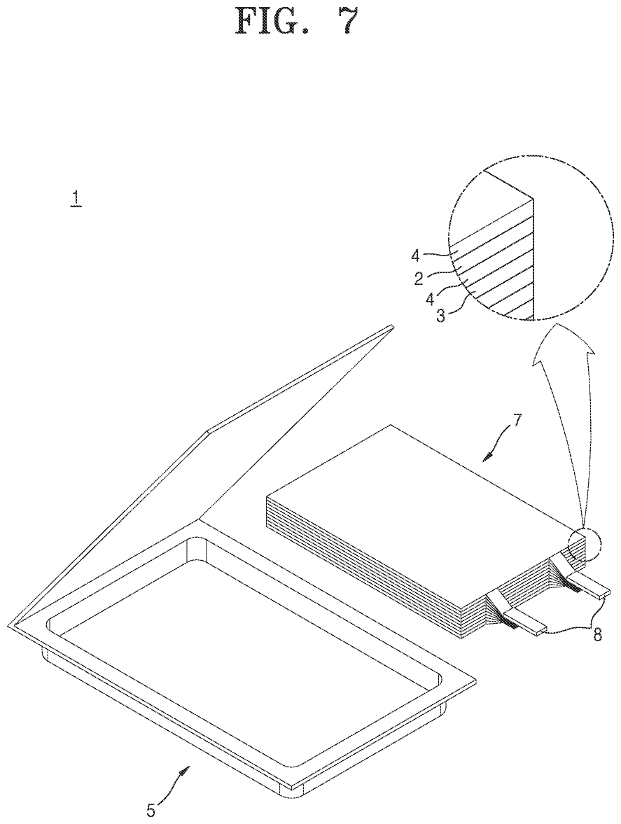

Referring to FIG. 7, a lithium metal battery 1 according to one or more embodiments may include a cathode 3, the above-described anode 2, and a separator 4. The separator 4 is disposed between the cathode 3 and the anode 2 to form a battery assembly 7. The battery assembly 7 is stacked in a bi-cell structure and accommodated in a battery case 5. The lithium metal battery 1 may include an electrode tab 8 serving as an electrical passage for inducing a current generated in the battery assembly 7 to the outside. An organic electrolytic solution is injected into the battery case 5 and the battery case 5 is sealed to complete preparation of the lithium metal battery 1. The battery case 5 may be a rectangular type or kind, but is not limited thereto, and for example, in some embodiments, a cylindrical type or kind or a thin film type or kind may also be utilized.

In a pouch-type or kind lithium metal battery, a pouch may be utilized as a battery case for each of the lithium metal batteries shown in FIGS. 5 to 7. A pouch-type or kind lithium metal battery may include at least one battery assembly. The separator is disposed between the cathode and the anode to form a battery assembly. The battery assembly is stacked in a bi-cell structure, impregnated with an organic electrolytic solution, accommodated in a pouch, and sealed to complete preparation of the pouch-type or kind lithium metal battery. For example, in some embodiments, the above-described cathode, anode and separator may be simply stacked in a battery assembly and accommodated in a pouch. In some embodiments, the cathode, the anode, and the separator may be wound in a jelly-roll form or folded in a battery assembly and accommodated in a pouch. Subsequently, an organic electrolytic solution is injected into the pouch and the pouch is sealed to complete preparation of the lithium battery.

Because the lithium metal batteries according to the disclosure has high discharging capacity, excellent or suitable lifespan characteristics, and high energy density, the lithium metal batteries may be utilized, for example, in electric vehicles (EVs). For example, lithium metal batteries may be utilized in hybrid vehicles such as plug-in hybrid electric vehicles (PHEVs). In some embodiments, lithium metal batteries may be utilized in the fields requiring a large amount of power storage. For example, lithium metal batteries may be utilized in E-bikes and electric tools.

In one or more embodiments, a plurality of lithium metal batteries may be stacked to form a battery module, and a plurality of battery modules constitutes a battery pack. Such battery packs may be utilized in any device that requires high capacity and high output. For example, battery packs may be utilized in laptop computers, smart phones, and electric vehicles. For example, in some embodiments, a battery module may include a plurality of batteries and a frame holding the batteries. The battery pack may include, for example, a plurality of battery modules and a bus bar connecting the battery modules. In some embodiments, the battery module and/or the battery pack may further include a cooling device. The plurality of battery packs are controlled or selected by a battery management system. The battery management system includes a battery pack, and a battery control device connected to the battery pack.

Hereinafter, a lithium metal battery including a solid electrolyte will be described in more detail.

### All-Solid Lithium Metal Battery

In one or more embodiments, the lithium metal battery may be, for example, an all-solid lithium metal battery including a solid electrolyte. An all-solid lithium metal battery may have both (e.g., simultaneously) improved capacity and excellent or suitable lifespan characteristics by including the above-described anode.

Although the all-solid lithium metal battery may be prepared, for example, by the following example method, the method is not limited thereto and may be adjusted according to required conditions.

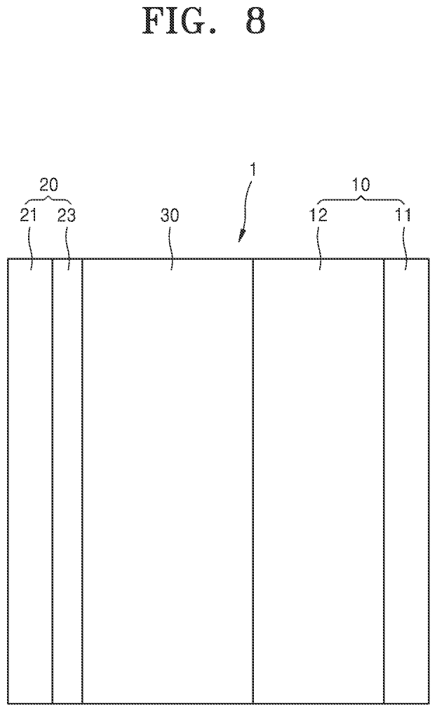

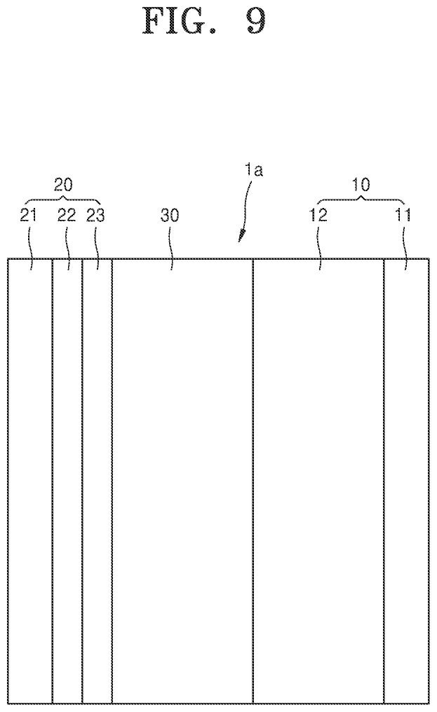

Referring to FIG. 8 and FIG. 9, in one or more embodiments, an all-solid lithium metal battery 1 may include a cathode 10, the above-described anode 20, and a solid electrolyte layer 30 between the cathode 10 and the anode 20. The solid electrolyte layer 30 may include, for example, an inorganic solid electrolyte. The solid electrolyte layer 30 may be, for example, a sulfide-based solid electrolyte or an oxide-based solid electrolyte.

### Anode

The above-described anode including lithium metal or a lithium alloy may be prepared.

### Cathode

Referring to FIG. 8 and FIG. 9, in one or more embodiments, the cathode 10 may include a cathode current collector 11 and a cathode active material layer 12 on the cathode current collector 11. The cathode active material layer 12 may include a cathode active material. For the cathode active material, it may refer to the above-described lithium battery.

In one or more embodiments, the cathode active material layer 12 may further include a solid electrolyte in addition to the cathode active material. The solid electrolyte included in the cathode 10 may be the same as or different from the solid electrolyte included in the solid electrolyte layer 30. For detailed descriptions of the solid electrolyte included in the cathode 10, the reference may refer to the solid electrolyte described above. The solid electrolyte utilized in the cathode active material layer 12 may have a smaller average particle diameter D50 than that of the solid electrolyte utilized in the solid electrolyte layer 30. For example, the average particle diameter D50 of the solid electrolyte utilized in the cathode active material layer 12 may be 90% or less, 80% or less, 70% or less, 60% or less, 50% or less, 40% or less, 30% or less, or 20% or less of the average particle diameter D50 of the solid electrolyte utilized in the solid electrolyte layer 30. The average particle diameter D50 of the solid electrolyte utilized in the cathode active material layer 12 may be, for example, from 0.1 μm to 2 μm, from 0.2 μm to 1.5 μm, or from 0.3 μm to 1.0 μm. An amount of the solid electrolyte included in the cathode active material layer 12 may be from 1 wt % to 15 wt %, from 5 wt % to 15 wt %, or from 8.0 wt % to 12.0 wt % based on a total weight of the cathode active material layer 12.

In one or more embodiments, the cathode active material layer 12 may include a binder. The binder may be styrene butadiene rubber (SBR), polytetrafluoroethylene, polyvinylidene fluoride, or polyethylene, but embodiments of the present disclosure are not limited thereto, and any binders commonly available in the art may also be utilized. An amount of the binder included in the cathode active material layer 12 may be, for example, from 0.1 wt % to 5 wt %, from 0.5 wt % to 3 wt %, or from 1.0 wt % to 2.0 wt % based on a total weight of the cathode active material layer 12.

In one or more embodiments, the cathode active material layer 12 may include a conductive material. The conductive material may be, for example, a carbonaceous conductive material and/or a metallic conductive material. The conductive material may be, for example, graphite, carbon black, acetylene black, Ketjen black, carbon fiber, carbon tube, and/or metal powder, but embodiments of the present disclosure are not limited thereto, and any conductive materials commonly available in the art may also be utilized. An amount of the conductive material included in the cathode active material layer 12 may be, for example, from 0.1 wt % to 10 wt %, from 0.5 wt % to 5 wt %, or from 1.0 wt % to 4.0 wt % based on the total weight of the cathode active material layer 12. In some embodiments, the cathode active material layer 12 may further include, for example, a filler, a coating agent, a dispersant, and/or an ion-conductive adjuvant in addition to the cathode active material, the solid electrolyte, the binder, and the conductive material.

The cathode current collector 11 may be, for example, in the form of a plate or a foil formed of aluminum (Al), indium (In), copper (Cu), magnesium (Mg), stainless steel, titanium (Ti), iron (Fe), cobalt (Co), nickel (Ni), zinc (Zn), germanium (Ge), lithium (Li), or an alloy thereof. In some embodiments, the cathode current collector 11 may not be provided. In some embodiments, the cathode current collector 11 may further include a carbon layer disposed on one side or both (e.g., simultaneously) sides of a metal substrate. By additionally disposing the carbon layer on the metal substrate, corrosion of the metal of the metal substrate caused by the solid electrolyte included in the cathode may be prevented or reduced and interfacial resistance between the cathode active material layer 12 and the cathode current collector 11 may be reduced. A thickness of the carbon layer may be, for example, from 1 μm to 5 μm, from 1 μm to 4 μm, or from 1 μm to 3 μm. In the embodiments in which the thickness of the carbon layer is too small, it may be difficult to completely prevent or reduce contact between the metal substrate and the solid electrolyte. In the embodiments in which the thickness of the carbon layer is too large, energy density of an all-solid secondary battery may decrease. The carbon layer may include amorphous carbon, crystalline carbon, and/or the like. A thickness of the cathode current collector 11 including a metal substrate and, optionally, a carbon layer may be, for example, from 10 μm to 50 μm, from 10 μm to 40 μm, or from 10 μm to 30 μm, but is not limited thereto, and may vary according to required characteristics of the all-solid lithium battery.

In one or more embodiments, the cathode 10 may include the cathode current collector 11 and the cathode active material layer 12 on the cathode current collector 11 and may further include an inactive member disposed on side of the cathode active material layer 12. An area of the cathode active material layer 12 may be smaller than an area of the solid electrolyte layer 30 in contact with the cathode active material layer 12. Because the inactive member is arranged to surround side (or be around) surfaces of the cathode active material layer 12, an area error between the cathode active material layer 12 and the solid electrolyte layer 30 may be corrected. The inactive member is a member not including an electrochemically active material, e.g., an electrode active material. The electrode active material is a material that allows intercalation/deintercalation of lithium. The inactive member is formed of a material commonly utilized in the art, other than the electrode active material. The inactive member may be in contact with the solid electrolyte layer 30 in a state around (e.g., surrounding) side surfaces of the cathode active material layer 12. Because the inactive member is in contact with the solid electrolyte layer 30 while around (e.g., surrounding) side surfaces of the cathode active material layer 12, cracks of the solid electrolyte layer 30 caused by a pressure difference during a press-applying process in a portion of the solid electrolyte layer 30 not in contact with the cathode active material layer 12 may be effectively inhibited. Because the difference between the area of the cathode active material layer 12 and the area of the solid electrolyte layer 30 is corrected by the inactive member, cracks of the solid electrolyte layer 30 caused by a pressure difference during a pressing process may be effectively inhibited. The inactive member may be disposed between the cathode current collector 11 and the solid electrolyte layer 30 facing each other. The inactive member may serve as a filler filling a space between the cathode current collector 11 and the solid electrolyte layer 30 facing each other. In one or more embodiments, the inactive member may include at least one selected from a lithium-ion insulator and a lithium-ion conductor. The inactive member may be an electronic insulator. For example, the inactive member may not be an electronic conductor. In some embodiments, the inactive member may be an organic material, an inorganic material, or an organic/inorganic composite material. The organic material may be, for example, a polymer. The inorganic material may be, for example, a ceramic such as a metal oxide. The organic/inorganic composite material may be a composite of a polymer and a metal oxide. In some embodiments, the inactive member may include, for example, at least one selected from an insulating polymer, an ion-conductive polymer, an insulating inorganic material, an oxide-based solid electrolyte, and a sulfide-based solid electrolyte. In some embodiments, the inactive member may be, for example, an olefin-based polymer such as polypropylene (PP) and polyethylene (PE). In some embodiments, the inactive member may be, for example, a gasket. The thickness of the inactive member may be the same as or similar to the thickness of the cathode active material layer 12.

### Solid Electrolyte Layer

Referring to FIG. 8 and FIG. 9, in one or more embodiments, a solid electrolyte layer 30 may be disposed between the cathode 10 and the anode 20 and includes, for example, a sulfide-based solid electrolyte.

The sulfide-based solid electrolyte may include, for example, at least one selected from Li₂S—P₂S₅, Li₂S—P₂S₅—LiX (where X is a halogen atom) Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are positive numbers, and Z is Ge, Zn, or Ga), Li₂S—GeS₂, Li₂S—SiS₂—Li₃PO₄, Li₂S—SiS₂—LiₚMO_{q}(where p and q are positive numbers and M is P, Si, Ge, B, Al, Ga, or In), Li₇₋ₓPS₆₋ₓClₓ (where 0≤x≤2), Li₇₋ₓPS₆₋ₓBrₓ (where 0≤x≤2), and Li₇₋ₓPS₆₋ₓIₓ (where 0≤x≤2). The sulfide-based solid electrolyte may be prepared by treating a starting material such as Li₂S and P₂S₅ by melt quenching or mechanical milling. In some embodiments, heat treatment may be performed after such treatment. The solid electrolyte may be in an amorphous state, a crystalline state, or a mixed state thereof. In some embodiments, the solid electrolyte may include, for example, sulfur (S), phosphorus (P), and lithium (Li) as components among materials of the above-described sulfide-based solid electrolytes. For example, in some embodiments, the solid electrolyte may be a material including Li₂S—P₂S₅. In the embodiments in which the material including Li₂S—P₂S₅ is utilized as the sulfide-based solid electrolyte material constituting the solid electrolyte, a mixing molar ratio of Li₂S to P₂S₅ may be, for example, from 50:50 to 90:10.

In one or more embodiments, the sulfide-based solid electrolyte may include, for example, an argyrodite type or kind solid electrolyte represented by Formula 1:

Li⁺¹₂₋ₙ₋ₓAⁿ⁺X²⁻₆₋ₓY⁻ₓ Formula 1

In Formula 1, A may be P, As, Ge, Ga, Sb, Si, Sn, Al, In, Ti, V, Nb, or Ta, X may be S, Se, or Te, and Y may be Cl, Br, I, F, CN, OCN, SCN, or N₃, where 1≤n≤5 and 0≤x≤2. In some embodiments, the sulfide-based solid electrolyte may be an argyrodite-type or kind compound including, for example, at least one selected from Li₇₋ₓPS₆₋ₓClₓ (where 0≤x≤2), Li₇₋ₓPS₆₋ₓBrₓ (where 0≤x≤2), and Li₇₋ₓPS₆₋ₓIₓ (where 0≤x≤2). In some embodiments, the sulfide-based solid electrolyte may be an argyrodite-type or kind compound including, for example, at least one selected from Li₆PS₅Cl, Li₆PS₅Br, and Li₆PS₅I. The argyrodite-type or kind solid electrolyte may have a density of 1.5 g/cc to 2.0 g/cc. Because the argyrodite-type or kind solid electrolyte has a density of 1.5 g/cc or more, internal resistance of the all-solid secondary battery may be reduced and penetration of the solid electrolyte layer may be effectively inhibited.

In one or more embodiments, the sulfide-based solid electrolyte may have, for example, an elastic modulus, i.e., Young's modulus, of 35 GPa or less, 30 GPa or less, 27 GPa or less, 25 GPa or less, or 23 GPa or less. In some embodiments, the sulfide-based solid electrolyte may have, for example, an elastic modulus, i.e., Young's modulus, of 10 GPa to 35 GPa, 10 GPa to 30 GPa, 10 GPa to 27 GPa, 10 GPa to 25 GPa, or 10 GPa to 23 GPa. Because the sulfide-based solid electrolyte has the elastic modulus within the ranges described above, temperature and/or pressure required for sintering decrease, and thus sintering of the solid electrolyte may be more easily performed.

In one or more embodiments, the solid electrolyte utilized in the solid electrolyte layer 30 may have an average particle diameter D50 of, for example, 1 μm to 10 μm, 1.5 μm to 7 μm, or 2 μm to 5 μm.

In one or more embodiments, an amount of the sulfide-based solid electrolyte included in the solid electrolyte layer 30 may be, for example, from 97 wt % to 100 wt %, from 98 wt % to 99.9 wt %, or from 98.5 wt % to 99.0 wt % based on a total weight of the solid electrolyte layer 30.

For example, in some embodiments, the solid electrolyte layer 30 may further include a binder. The binder included in the solid electrolyte layers 30 may be, for example, styrene butadiene rubber (SBR), polytetrafluoroethylene, polyvinylidene fluoride, and/or polyethylene. However, the binder is not limited thereto, and any compound commonly utilized in the art as a binder may also be utilized. The binder of the solid electrolyte layer 30 may be the same as or different from the binders included in the cathode active material layer 12 and the anode active material layer 22.

An amount of the binder included in the solid electrolyte layer 30 may be, for example, from 0.1 wt % to 3 wt %, from 0.5 wt % to 2 wt %, or from 1.0 wt % to 2.0 wt % based in a total weight of the solid electrolyte layer 30.

Referring to FIG. 8 and FIG. 9, in one or more embodiments, the all-solid lithium metal battery 1 may include a solid electrolyte layer 30, a cathode layer 10 on one side of the solid electrolyte layer 30, and an anode layer 20 on the other side of the solid electrolyte layer 30. The cathode layer 10 may include a cathode active material layer 12 in contact with the solid electrolyte layer 30 and a cathode current collector 11 in contact with the cathode active material layer 12. The anode layer 20 may include a protective layer 23, the protective layer 23 in contact with the solid electrolyte layer 30 and the protective 23 in contact with an anode active material layer 22. In some embodiments, the anode layer 20 may include an anode active material layer 22 and an protective layer 23, the protective layer 23 in contact with the solid electrolyte layer 30 and an anode current collector 21 in contact with the anode active material layer 22. For example, the all-solid lithium metal battery 1 may be prepared by disposing the cathode active material layer 12 and the protective layer 23 on respective side of the solid electrolyte layer 30, and disposing the cathode current collector 11 and the anode current collector 21 on the cathode active material layer 12 and the protective layer 23, respectively. For example, in some embodiments, the all-solid lithium metal battery 1a may be prepared by disposing the cathode active material layer 12 and the protective layer 23/the anode active material layer 22 on respective side of the solid electrolyte layer 30 and disposing the cathode current collector 11 and the anode current collector 21 on the cathode active material layer 12 and the anode active material layer 22, respectively. In some embodiments, an all-solid lithium metal battery 1 may be prepared by sequentially stacking the protective layer 23, the solid electrolyte layer 30, the cathode active material layer 12, and the cathode current collector 11, on the anode current collector 21.

In some embodiments, an all-solid lithium metal battery 1a may be prepared by sequentially stacking the anode active material layer 22, the protective layer 23, the solid electrolyte layer 30, the cathode active material layer 12, and the cathode current collector 11, on the anode current collector 21.

### Method of Manufacturing Anode for Lithium Metal Battery

A method of manufacturing an anode for a lithium metal battery according to one or more embodiments of the present disclosure may include: providing an anode current collector or providing a stack structure in which an anode active material layer is disposed on an anode current collector; and providing a protective layer on the anode current collector or on the anode active material layer, wherein the protective layer may include sulfurized polyacrylonitrile (SPAN). A lithium metal battery including the anode prepared according to the method has improved cycle characteristics.

First, an anode current collector is provided. For the anode current collector, the reference may refer to the above-described anode. For example, in some embodiments, a copper foil may be provided as the anode current collector. In some embodiments, a stack structure in which the anode active material layer is disposed on the anode current collector may be provided. A method for disposing the anode active material layer on the anode current collector is not particularly limited. For example, in some embodiments, a lithium metal layer may be disposed on a metal substrate (e.g., as the anode current collector) by sputtering, and/or the like. In some embodiments, for example, a lithium foil may be disposed on a metal substrate, followed by rolling, to prepare a copper foil/lithium foil stack structure. In some embodiments, a commercially available stack structure in which a lithium metal layer is stacked on a copper foil may be utilized. In some embodiments, a stack structure may be prepared by coating a metal substrate with a composition including lithium powder and a binder and drying the coated composition. For the lithium powder and the binder, the reference may refer to the above-described anode.

Subsequently, a protective layer is provided on the anode current collector or on the anode active material layer. For example, in some embodiments, the protective layer may be formed by preparing a slurry by mixing sulfurized polyacrylonitrile SPAN, a binder, and a solvent, coating the metal substrate (anode current collector) or the anode active material layer with the slurry, and drying the coated slurry. Coating methods are not particularly limited, for example, in some embodiments, the coating may be performed by utilizing doctor blade, and/or the like. The slurry may include, for example, sulfurized polyacrylonitrile SPAN, the binder, and the solvent. In some embodiments, the slurry may further include a metal oxide. The slurry may include, for example, sulfurized polyacrylonitrile SPAN, the metal oxide, the binder, and the solvent. In some embodiments, the slurry may further include a carbonaceous material. The slurry may include, for example, sulfurized polyacrylonitrile SPAN, the carbonaceous material, the binder, and the solvent. In some embodiments, the slurry may include, for example, sulfurized polyacrylonitrile SPAN, the metal oxide, the carbonaceous material, the binder, and the solvent. For the metal oxide, the carbonaceous material, and the binder, the reference may refer to the above-described anode. The solvent may be an organic solvent. The solvent may be, for example, NMP, but is not limited thereto, and any solvents commonly available in the art may also be utilized.

In the embodiments of directly preparing sulfurized polyacrylonitrile SPAN, for example, a method described herein may be utilized.

A raw material mixture of polyacrylonitrile powder and sulfur powder is heated. The raw material mixture may be mixed utilizing a common mixing device such as a mixer, a mortar, and/or a ball mill. As the raw material mixture, a simple mixture of sulfur and polyacrylonitrile may be utilized. In some embodiments, the raw material mixture may be molded into a pellet form and utilized. The raw material mixture may include (e.g., consist of) polyacrylonitrile and sulfur (S) or may further include materials common applicable to the anode, such as a conductive material.

By heating the raw material mixture during a heat treatment process, sulfur (S) contained in the raw material mixture is introduced into a structure of polyacrylonitrile. The heat treatment process may be performed in a closed system or in an open system. In order to suppress or reduce the loss of sulfur (S) vapor, the heat treatment process may be performed in a closed system. An atmosphere for the heat treatment process may be, for example, an atmosphere that does not prevent or reduce sulfur (S) from being introduced into polyacrylonitrile, e.g., an atmosphere not containing hydrogen, or a non-oxidizing atmosphere. In the case where hydrogen is present in a heat treatment atmosphere, sulfur (S) reacts with hydrogen to generate hydrogen sulfide in a reaction system, and thus sulfur may be removed from the reaction system. By performing the heat treatment in a non-oxidizing atmosphere, sulfur in a vapor state reacts with polyacrylonitrile concurrently (e.g., simultaneously) with ring closure reaction of polyacrylonitrile, thereby obtaining sulfurized polyacrylonitrile SPAN. The non-oxidizing atmosphere may include an atmosphere in which a pressure is reduced to a low oxygen concentration to the extent that oxidation does not proceed, an inert gas atmosphere such as a nitrogen or argon atmosphere, and/or a sulfur gas atmosphere. The non-oxidizing atmosphere in a closed state may be obtained by adding the raw material mixture to a container in which airtightness is maintained to the extent that sulfur (S) vapor is not lost and heating the container in which a reduced pressure or an inert gas atmosphere is maintained. In some embodiments, the raw material mixture may be heated in a vacuum-packed state with an aluminum laminate film and/or the like inhibiting reaction with sulfur vapor. The heat treatment temperature of the raw material mixture in the heat treatment process may be a temperature at which sulfur may be introduced into polyacrylonitrile and the generated sulfurized polyacrylonitrile is not denatured. The heat treatment temperature may be from 250° C. to 500° C., from 250° C. to 400° C., or from 250° C. to 300° C. The heat treatment temperature may be a temperature equal to or higher than a temperature at which sulfur (S) vaporizes. Vaporization refers to a phase change of sulfur from a liquid or solid to gas and the phase change may occur by boiling, evaporation, and sublimation. For example, a melting point of α-sulfur (S, rhombic sulfur) is 112.8° C., a melting point of β-sulfur (S, monoclinic sulfur) is 119.6° C., and a melting point of γ-sulfur (S, monoclinic sulfur) is 106.8° C. A boiling point of sulfur (S) is 444.7° C. Because a vapor pressure of sulfur is high, generation of sulfur vapor may be visually observed at a temperature of the raw material mixture of 150° C. or higher. In the embodiments in which the temperature of the raw material mixture is 150° C. or higher, sulfur reflux is possible. In the embodiments in which sulfur is refluxed in the heat treatment process, a refluxing device may be utilized. Even in the embodiments in which the sulfur content (e.g., amount) is excessive in the raw material mixture, a sufficient amount of sulfur (S) may be introduced into polyacrylonitrile during the heat treatment process. In the embodiments in which an excess of sulfur is utilized relative to polyacrylonitrile, problems may be prevented or reduced by removing the elemental sulfur from a heat-treated resultant after the heat treatment process. Adverse effects may be inhibited. In the embodiments in which a mixing weight ratio of polyacrylonitrile and sulfur is from 1:2 to 1:10 in the raw material mixture, a sufficient amount of sulfur may be introduced into polyacrylonitrile while inhibiting adverse effects caused by remaining elemental sulfur by removing the elemental sulfur at a temperature of 200° C. to 250° C. while reducing a pressure of the heat-treated resultant after the heat treatment process. In the embodiments in which the process of removing elemental sulfur from the heat-treated resultant is not performed after the heat treatment process, the heat-treated resultant may be utilized as sulfurized polyacrylonitrile. In the embodiments in which the elemental sulfur is removed from the heat-treated resultant after the heat treatment process, the heat-treated resultant after the elemental sulfur-removing process may be utilized as sulfurized polyacrylonitrile. In some embodiments, the element sulfur-removing process may be performed, for example, for 1 hour to 6 hours. After heating the sulfurized polyacrylonitrile from room temperature to 900° C. at a heating ratio of 20° C./min, a mass loss obtained by thermogravimetric analysis is 10% or less at 400° C. In contrast, in the embodiments in which a mixture of sulfur powder and polyacrylonitrile powder is heated under the same conditions, a mass loss starts at about 120° C. and a large mass loss occurs at a temperature of 200° C. or higher due to a rapid loss of sulfur. Sulfur (S) in the sulfurized polyacrylonitrile may be present in a stable state combined with polyacrylonitrile or as an elemental sulfur but trapped in a cross-linked structure during ring closure of polyacrylonitrile, and thus sulfur is difficult to evaporate even if heated. The prepared sulfurized polyacrylonitrile may be in a powder state.

Hereinafter, one or more example embodiments of the present disclosure will be described in more detail with reference to the following examples and comparative examples. However, these examples are not intended to limit the purpose and scope of the one or more example embodiments.

### Example 1: Cu Substrate/Li Metal Layer/SPAN-Containing Protective Layer Anode Preparation of Anode

Sulfurized polyacrylonitrile (SPAN) having an average particle diameter (D50) of 0.5 μm and polyvinylidene fluoride (PVDF) as a binder were prepared in a weight ratio of 9:1 and dry-mixed utilizing a Thinky mixer at 100 rpm for 5 minutes to prepare a mixture. A solvent, N-methyl-2-pyrrolidone (NMP), was added to the mixture to prepare a slurry. The slurry was coated on a 20 μm-thick lithium metal thin film disposed on a copper current collector utilizing a doctor blade and dried in a vacuum oven at 70° C. to prepare an anode. The anode had a structure in which a protective layer having a thickness of 10 μm was formed on the lithium metal thin film disposed on the copper current collector.

### Preparation of Cathode

LiCoO₂ powder and a carbonaceous conductive material (Super-P; Timcal Ltd.) were uniformly mixed in a weight ratio of 90:5, and a polyvinylidene fluoride (PVDF) binder solution was added thereto such that a weight ratio of active material (LiCoO₂ powder):carbonaceous conductive material:binder was 90:5:5, to prepare a cathode active material slurry.

The prepared slurry was coated on a 15 μm-thick aluminum substrate utilizing a doctor blade and dried at 120° C. under a reduced pressure, and then rolled utilizing a roll press into a sheet to prepare a cathode.

### Preparation of Coin Cell

A polypropylene separator (Celgard 3510) was disposed between the cathode and the anode and an electrolyte was injected thereinto to prepare a coin cell.

As the electrolyte, a solution in which 1.15 M LiPF₆ was dissolved in a mixture of ethylene carbonate (EC), ethyl methyl carbonate (EMC), and dimethyl carbonate (DMC) in a volume ratio of 2:4:4 was utilized.

### Example 2: Cu Substrate/Li Metal Layer/SPAN+Nb₂O₅-Containing Protective Layer Anode

An anode and a coin cell were prepared in substantially the same manner as in Example 1, except that a protective layer was prepared by mixing sulfurized polyacrylonitrile SPAN having an average particle diameter (D50) of 0.5 μm, Nb₂O₅ as a metal oxide, and polyvinylidene fluoride (PVDF) as a binder in a weight ratio of 8:1:1.

### Example 3: Cu Substrate/Li Metal Layer/SPAN+Nb₂O₅+DB Protective Layer Anode

An anode and a coin cell were prepared in substantially the same manner as in Example 1, except that a protective layer was prepared by mixing sulfurized polyacrylonitrile SPAN having an average particle diameter (D50) of 0.5 μm, Nb₂O₅ as a metal oxide, Denka Black, which is amorphous carbon, as a carbonaceous conductive material, and polyvinylidene fluoride (PVDF) as a binder in a weight ratio of 4:1:3.33:0.93.

### Example 4: Cu Substrate/Li Metal Layer/SPAN+TiO₂+DB Protective Layer Anode

An anode and a coin cell were prepared in substantially the same manner as in Example 1, except that a protective layer was prepared by mixing sulfurized polyacrylonitrile SPAN having an average particle diameter (D50) of 0.5 μm, TiO₂ as a metal oxide, Denka Black, which is amorphous carbon, as a carbonaceous conductive material, and polyvinylidene fluoride (PVDF) as a binder in a weight ratio of 4:1:3.33:0.93.

### Example 5: Cu Substrate/SPAN+Nb₂O₅+DB Protective Layer Anode

An anode and a coin cell were prepared in substantially the same manner as in Example 1, except that a 30 μm-thick copper current collector was utilized instead of the 20 μm-thick lithium metal thin film disposed on the copper current collector.

The anode having a structure in which the protective layer was directly disposed on the copper current collector was utilized.

### Comparative Example 1: Cu Substrate/Li Metal Layer/—S—S-Bond-Containing Polymer Protective Layer Anode

An anode and a coin cell were prepared in substantially the same manner as in Example 1, except that an —S—S-(disulfide)-bond-containing polymer (poly(sulfur-random-(1,3-diisopropenylbenzene) was utilized instead of the sulfurized polyacrylonitrile SPAN having an average particle diameter D50 of 0.5 μm.

### Comparative Example 2: Cu Substrate/Li Metal Layer/PAN-Containing Protective Layer Anode

An anode and a coin cell were prepared in substantially the same manner as in Example 1, except that a protective layer was prepared by utilizing polyacrylonitrile (PAN) having an average particle diameter of 1 μm (weight average molecular weight of 160,000 Dalton) instead of the sulfurized polyacrylonitrile SPAN having an average particle diameter (D50) of 0.5 μm, and mixing the polyacrylonitrile (PAN), Denka Black, which is amorphous carbon, as a carbonaceous conductive material, and polyvinylidene fluoride (PVDF) as a binder in a weight ratio of 5:3.33:0.93.

### Comparative Example 3: Cu Substrate/Li Metal Layer/Heat-Treated PAN-Containing Protective Layer Anode

An anode and a coin cell were prepared in substantially the same manner as in Example 1, except that a protective layer was prepared by utilizing heat-treated polyacrylonitrile (PAN) instead of the sulfurized polyacrylonitrile SPAN having an average particle diameter (D50) of 0.5 μm, Denka Black, which is amorphous carbon, as a carbonaceous conductive material, and polyvinylidene fluoride (PVDF) as a binder in a weight ratio of 5:3.33:0.93.

The heat-treated polyacrylonitrile was prepared by heat-treating polyacrylonitrile (PAN, having an average particle diameter of 1 μm and a weight average molecular weight of 160,000 Dalton). The heat treatment was performed in an argon atmosphere. After putting polyacrylonitrile powder into a furnace, temperature was increased from 25° C. to 350° C. at a heating ratio of 10° C./min and maintained at 350° C. for 6 hours, and then the furnace was cooled to prepare heat-treated polyacrylonitrile.

### Comparative Example 4: Cu Substrate/Li Metal Layer/Nb₂O₅ Protective Layer Anode

An anode and a coin cell were prepared in substantially the same manner as in Example 1, except that a protective layer was prepared by mixing Nb₂O₅ as a metal oxide and polyvinylidene fluoride (PVDF) as a binder in a weight ratio of 9:1.

### Comparative Example 5: Cu Substrate/Li Metal Layer Anode

An anode and a coin cell were prepared in substantially the same manner as in Example 1, except that a protective layer was not disposed.

### Evaluation Example 1: Charging/Discharging Test (I)

Each of the lithium batteries prepared in Example 3, Example 5, and Comparative Example 5 was charged with a constant current of 0.1 C rate at 25° C. until a voltage reached 4.2 V (vs. Li), and the charging process was cut-off at a rate of 0.05 C rate in a constant voltage mode while the voltage of 4.2 V was maintained. Subsequently, the lithium battery was discharged with a constant current of 0.1 C rate until the voltage reached 3.0 V (vs. Li) during discharging (formation cycle).

The lithium battery that had undergone the formation cycle was charged with a constant current with a current of 0.2 C rate at 25° C. until the voltage reached 4.2 V (vs. Li), and then the charging process was cut-off at a current of 0.05 C rate in a constant voltage mode while maintaining the voltage of 4.2 V. Subsequently, the lithium battery was discharged with a constant current of 0.2 C rate until the voltage reached 3.0 V (vs. Li) during discharging (1^{st} cycle). The cycle was then repeated to a 200^{th} cycle under the same conditions.

The lithium batteries were each rested for 10 minutes after every charging/discharging cycle. Some results of the room temperature charging/discharging test are shown in Table 1. Capacity retention ratio is defined as shown Equation 1.

Capacity retention ratio [%]=[Discharging capacity at 200^{th} cycle/discharging capacity at 1^{st} cycle]×100 Equation 1

TABLE 1

| | Composition of | Capacity Retention |
|---|---|---|
| | Protective Layer | Ratio [%] |
| Example 3 | SPAN + Nb₂O₅ + DB | 72 |
| Comparative | — | 44 |
| Example 5 | | |

As shown in Table 1, the lithium battery of Example 3 had an increased capacity retention ratio compared to the lithium battery of Comparative Example 5.

It is considered that such a high capacity retention ratio could be obtained because deterioration of the anode active material layer was effectively inhibited by the protective layer including sulfurized polyacrylonitrile.

The lithium battery of Comparative Example 5 not including a protective layer showed poor lifespan characteristics.

Although not shown in Table 1, it was confirmed that charging/discharging of lithium batteries of Examples 4 and 5 was possible.

### Evaluation Example 2: Charging/Discharging Test (II)

Each of the lithium batteries prepared in Examples 1 and 2 and Comparative Examples 2 to 4 was charged with a constant current of 0.1 C rate at 25° C. until a voltage reached 4.3 V (vs. Li), and the charging process was cut-off at a rate of 0.05 C rate in a constant voltage mode while the voltage of 4.3 V was maintained. Subsequently, the lithium battery was discharged with a constant current of 0.1 C rate until the voltage reached 3.0 V (vs. Li) during discharging (formation cycle).

The lithium battery that had undergone the formation cycle was charged with a constant current with a current of 0.3 C rate at 25° C. until the voltage reached 4.3 V (vs. Li), and then the charging process was cut-off at a current of 0.05 C rate in a constant voltage mode while maintaining the voltage of 4.3 V. Subsequently, the lithium battery was discharged with a constant current of 0.3 C rate until the voltage reached 3.0 V (vs. Li) during discharging (1^{st} cycle). The cycle was then repeated to a 100^{th} cycle under the same conditions.

The lithium batteries were each rested for 10 minutes after every charging/discharging cycle. Some results of the room temperature charging/discharging tests are shown in Table 2. Capacity retention ratio is defined as shown Equation 2.

Capacity retention ratio [%]=[Discharging capacity at 100^{th} cycle/discharging capacity at 1^{st} cycle]×100 Equation 2

TABLE 2

| | Composition of | Capacity Retention |
|---|---|---|
| | Protective Layer | Ratio [%] |
| Example 1 | SPAN | 75 |
| Example 2 | SPAN + Nb₂O₅ | 88 |
| Comparative | —S—S— (disulfide)- | 18 |
| Example 1 | containing polymer | |
| Comparative | PAN + DB | 4 |
| Example 2 | | |
| Comparative | Heat-treated | 1 |
| Example 3 | PAN + DB | |
| Comparative | Nb₂O₅ | 58 |
| Example 4 | | |

As shown in Table 2, the lithium batteries according to Examples 1 and 2 each had increased capacity retention ratios compared to the lithium batteries of Comparative Examples 1 to 4.

It is considered that such high capacity retention ratios could be obtained because deterioration of the anode active material layer was effectively inhibited by the protective layer including sulfurized polyacrylonitrile.

The lithium battery of Example 2 had a higher capacity retention ratio than that of the lithium battery of Example 1. It is considered that because the protective layer of the lithium battery of Example 2 further includes the metal oxide, strength and/or elasticity of the protective layer was further improved and thus lithium ion conductivity was further improved.

The lithium batteries of Comparative Examples 1 to 4 had poor lifespan characteristics. It is considered that the protective layer could not effectively prevent or reduce deterioration of the anode active material layer in the lithium batteries of Comparative Examples 1 to 4.

As utilized herein, the singular forms “a,” “an,” and “the” are intended to include the plural forms as well, unless the context clearly indicates otherwise. Further, the utilization of “may” if describing embodiments of the present disclosure may refer to “one or more embodiments of the present disclosure”.

As utilized herein, the terms “substantially,” “about,” and similar terms are used as terms of approximation and not as terms of degree, and are intended to account for the inherent deviations in measured or calculated values that would be recognized by those of ordinary skill in the art.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

Although embodiments are described above with reference to illustrated drawing, the present disclosure is not limited thereto. It is obvious that one or more suitable alternations and modifications will be apparent to one or ordinary skill in the art to which this application belongs within protection coverage of the present disclosure.

According to an aspect, by including the anode for lithium metal batteries having the disclosed structure, deterioration of the anode active material layer may be prevented or reduced, and a lithium metal battery having improved cycle characteristics may be provided.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the drawings, it will be understood by those of ordinary skill in the art that one or more suitable changes in form and details may be made therein without departing from the spirit and scope of the disclosure as defined by the following claims and equivalents thereof.

What is claimed is:

1. An anode for a lithium metal battery, comprising:
an anode current collector; and
a protective layer on the anode current collector,
wherein an anode active material layer is disposed or absent between the anode current collector and the protective layer,
the protective layer comprises sulfurized polyacrylonitrile, and the anode active material layer comprises a lithium metal and/or a lithium alloy.

2. The anode for a lithium metal battery of claim 1, wherein the sulfurized polyacrylonitrile is in the form of particles, and an average particle diameter of the particles of the sulfurized polyacrylonitrile is from about 100 nm to about 10 μm.

3. The anode for a lithium metal battery of claim 1, wherein the protective layer further comprises Li₂S.

4. The anode for a lithium metal battery of claim 1, wherein the protective layer further comprises a binder, and the binder comprises a fluorine-based binder.

5. The anode for a lithium metal battery of claim 4, wherein the protective layer comprises 1 to 30 parts by weight of the binder, based on 100 parts by weight of the sulfurized polyacrylonitrile.

6. The anode for a lithium metal battery of claim 1, wherein the protective layer further comprises a metal oxide in the form of particles, and an average particle diameter of the particles of the metal oxide is from about 100 nm to about 2 μm.

7. The anode for a lithium metal battery of claim 6, wherein the metal oxide comprises Nb₂O₅, TiO₂, Al₂O₃, SiO₂, BaTiO₃, a metal organic framework, polyhedral oligomeric silsesquioxanes, Li₂CO₃, Li₃PO₄, Li₂O, montmorillonite, ZrO₂, CeO₂, Mn₃O₄, or a combination thereof.

8. The anode for a lithium metal battery of claim 6, wherein the metal oxide comprises a pseudo-capacitive oxide having lithiophilicity.

9. The anode for a lithium metal battery of claim 6, wherein the protective layer comprises 5 to 60 parts by weight of the metal oxide, based on 100 parts by weight of the sulfurized polyacrylonitrile.

10. The anode for a lithium metal battery of claim 1, wherein the protective layer further comprises a carbonaceous material, and the carbonaceous material is a carbonaceous conductive material.

11. The anode for a lithium metal battery of claim 10, wherein the carbonaceous material comprises amorphous carbon in the form of particles, and an average particle diameter of the particles of the amorphous carbon is from about 10 nm to about 100 nm.

12. The anode for a lithium metal battery of claim 10, wherein the carbonaceous material comprises carbon black, carbon nanotube, carbon nanofiber, fullerene, activated carbon, carbon fiber, or a combination thereof.

13. The anode for a lithium metal battery of claim 10, wherein the protective layer comprises 10 to 100 parts by weight of the carbonaceous material, based on 100 parts by weight of the sulfurized polyacrylonitrile.

14. The anode for a lithium metal battery of claim 1, wherein the protective layer has a thickness of about 3 μm to about 20 μm.

15. The anode for a lithium metal battery of claim 1, wherein the anode active material layer comprises lithium metal foil, lithium metal powder, lithium alloy foil, lithium alloy powder, or a combination thereof.

16. The anode for a lithium metal battery of claim 1, wherein the anode active material layer has a thickness of about 0.1 μm to about 80 μm.

17. A lithium metal battery comprising:
a cathode;
the anode according to claim 1; and
an electrolyte between the cathode and the anode.

18. The lithium metal battery of claim 17, wherein the electrolyte comprises a liquid electrolyte, a solid electrolyte, a gel electrolyte, or a combination thereof.

19. The lithium metal battery of claim 18, wherein the electrolyte comprises the solid electrolyte, the gel electrolyte, or a combination thereof, and wherein the solid electrolyte is an oxide-based solid electrolyte, a sulfide-based solid electrolyte, a polymer solid electrolyte, or a combination thereof, and the gel electrolyte comprises a polymer gel electrolyte.

20. The lithium metal battery of claim 17, wherein the cathode comprises a cathode current collector, and the anode comprises an anode current collector,
wherein at least one of the cathode current collector or the anode current collector comprises a base film and a metal layer on one side or both sides of the base film,
wherein the base film comprises a polymer, the polymer comprising polyethyleneterephthalate, polyethylene, polypropylene, polybutyleneterephthalate, polyimide, or a combination thereof, and
wherein the metal layer comprises indium, copper, magnesium, stainless steel, titanium, iron, cobalt, nickel, zinc, aluminum, germanium, lithium, or an alloy thereof.

21. A method for manufacturing an anode for a lithium metal battery, the method comprising:
providing an anode current collector or providing a stack structure in which an anode active material layer is on an anode current collector; and
providing a protective layer on the anode current collector or on the anode active material layer,
wherein the protective layer comprises sulfurized polyacrylonitrile, and the anode active material layer comprises a lithium metal and/or a lithium alloy.
